(19) United States
(12) Patent Application Publication
(10) Pub. No.: US 2025/0350445 A1
(43) Pub. Date: Nov. 13, 2025

(54) Enforcement of Immutable System Properties

(71) Applicant: Apple Inc., Cupertino, CA (US)

(72) Inventors: Ivan Krstic, San Francisco, CA (US); Anthony J. Chivetta, San Francisco, CA (US); Alexander Balducci, Cupertino, CA (US); Catherine Yun, Woodside, CA (US); Christian Priebe, Cupertino, CA (US); Cory Benfield, London (GB); Daniel E. Loffgren, Campbell, CA (US); David C. Zech, San Jose, CA (US); Jeremy C. Andrus, Mukilteo, WA (US); Jose A. Lozano Hinojosa, Sunnyvale, CA (US); Navin N. Pai, Cupertino, CA (US); Robert M. Lacroix, Santa Clara, CA (US); Thomas P. Devanneaux, Los Altos, CA (US); Thomas F. Pauly, Los Altos, CA (US); Vasanth Swaminathan, San Francisco, CA (US); Venkata Madan Kameswar Vellamcheti, Cupertino, CA (US); Wade Benson, Sunnyvale, CA (US); Yash Gupta, Mountain View, CA (US)

(21) Appl. No.: 19/203,057

(22) Filed: May 8, 2025

Related U.S. Application Data
(60) Provisional application No. 63/646,686, filed on May 13, 2024.
(60) Provisional application No. 63/647,451, filed on May 14, 2024.
(60) Provisional application No. 63/657,853, filed on Jun. 8, 2024.
(60) Provisional application No. 63/657,852, filed on Jun. 8, 2024.
(60) Provisional application No. 63/657,849, filed on Jun. 8, 2024.

(51) Int. Cl. H04L 9/08; H04L 9/32

(52) U.S. Cl. CPC H04L 9/0825; H04L 9/3236; H04L 9/3247

(57) ABSTRACT

Techniques are disclosed relating to improving user privacy when accessing a resource. In various embodiments, a server system provides a resource accessible to a plurality of client devices using end-to-end encryption. The server system provides a signed attestation that includes a public key of the server system, the attestation attesting to the public key and to a set of system properties of the server system that are immutable while the resource is accessible. The server system receives a request from one of the client devices to access the resource, the request including encrypted using the attested-to public key of the server system. In some embodiments, the server system publishes information about the immutable system properties to a transparency log stored in a transparency server accessible to the client device when verifying the signed attestation.

The present application claims priority to U.S. Prov. Appl. No. 63/657,853, entitled “Load Balancing with End-to-End Encryption,” filed Jun. 8, 2024, U.S. Prov. Appl. No. 63/657,852, entitled “Enforcement of Immutable System Properties,” filed Jun. 8, 2024, U.S. Prov. Appl. No. 63/657,849, entitled “Secure Supplemental Large Language Model (LLM) Processing,” filed Jun. 8, 2024, U.S. Prov. Appl. No. 63/647,451, entitled “Enforcement of Immutable System Properties,” filed May 14, 2024, and U.S. Prov. Appl. No. 63/646,686, entitled “Secure Supplemental Large Language Model (LLM) Processing,” filed May 13, 2024; the disclosures of each of the above-referenced applications are incorporated by reference herein in their entireties.

### BACKGROUND

### Technical Field

This disclosure relates generally to computing systems, and, more specifically, to improving user privacy when accessing resources such as machine learning (ML) models supplemented with server-provided information.

### Description of the Related Art

In recent years, machine learning models such as large language models (LL Ms) have gained widespread popularity. The availability of massive datasets and advances in computing power have enabled the training of these behemoth models, which can process and generate vast amounts of text with remarkable accuracy. M odels such as a bidirectional encoder representations from transformer (BERT), generative pre-trained transformer (GPT), large language model application (LLaMA), and other transformer-based language models have demonstrated impressive capabilities in natural language processing tasks such as language translation, sentiment analysis, and text classification. Their ability to learn complex patterns and relationships within vast amounts of text data has allowed them to generalize well across diverse linguistic contexts. As a result, large language models have been applied to a wide range of applications, including chatbots, virtual assistants, and content generation tools, revolutionizing the way we interact with technology and each other.

### BRIEF DESCRIPTION OF THE DRAWINGS

FIG. 1 is a block diagram illustrating an example of a system that securely processes LLM requests from a client device to one or more assisting server systems.

FIGS. 2A-2C are block diagrams illustrating an example of a server system generating public key attestation used to secure communication with the client device.

FIG. 3 is a block diagram illustrating an example of a rate limiting system using anonymized tokens for accessing the server systems.

FIGS. 4A and 4B are flow diagrams illustrating examples of methods performed by the client device and the server systems to process an LLM request.

FIG. 5 is a block diagram illustrating an example of a server system that provides a public key attestation attesting to immutable system properties of the server system.

FIG. 6 is a timing diagram illustrating an example timeline for implementing a restricted execution mode (REM) to enforce one or more of the immutable system properties of the server system.

FIG. 7A is a block diagram illustrating an example of a verification of trust caches identifying applications authorized to execute in the REM.

FIGS. 7B and 7C are block diagrams illustrating examples of using a transparency log for verifying public-key attestations.

FIG. 7D is a block diagram illustrating an example of trust cache personalization.

FIG. 8 is a block diagram illustrating an example of an execution authorization for a requested application.

FIG. 9 is a block diagram illustrating an example of generating a public-key attestation indicative of REM being implemented.

FIG. 10 is a block diagram illustrating an example of a secure circuit that can generate the public-key attestation.

FIGS. 11A and 11B are flow diagrams illustrating examples of methods performed by the client device and the server systems using the public-key attestation.

FIGS. 12A and 12B is a block diagram illustrating an example of a load balancing system using a load balancer to distribute requests among multiple server systems.

FIGS. 13A and 13B are flow diagrams illustrating examples of methods performed to load balance requests across server systems.

FIG. 14 is a block diagram illustrating an example computing system implementing functionality described herein.

FIG. 15 is a diagram illustrating example applications for systems and devices implementing functionality described herein.

FIGS. 16A-F are block diagrams illustrating examples of an application programing interface implementing functionality described herein.

### DETAILED DESCRIPTION

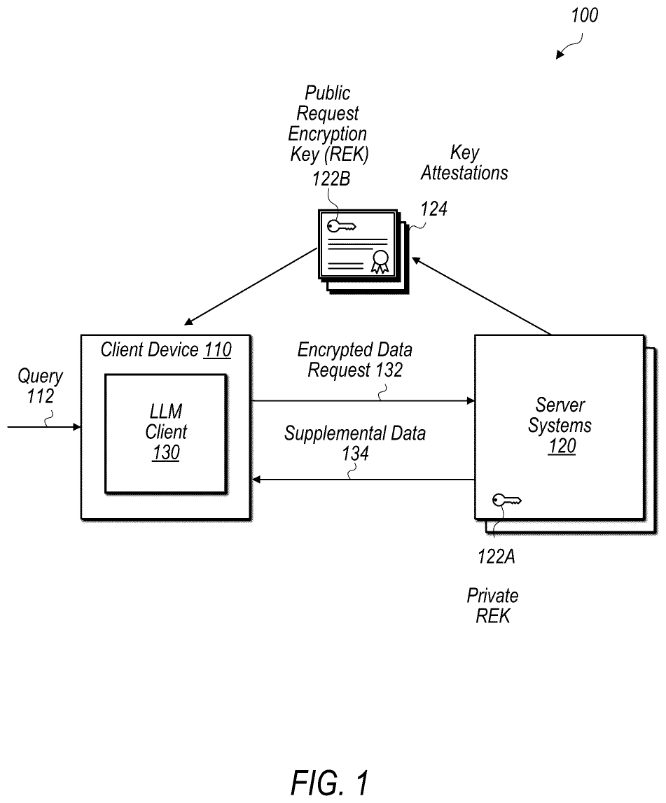

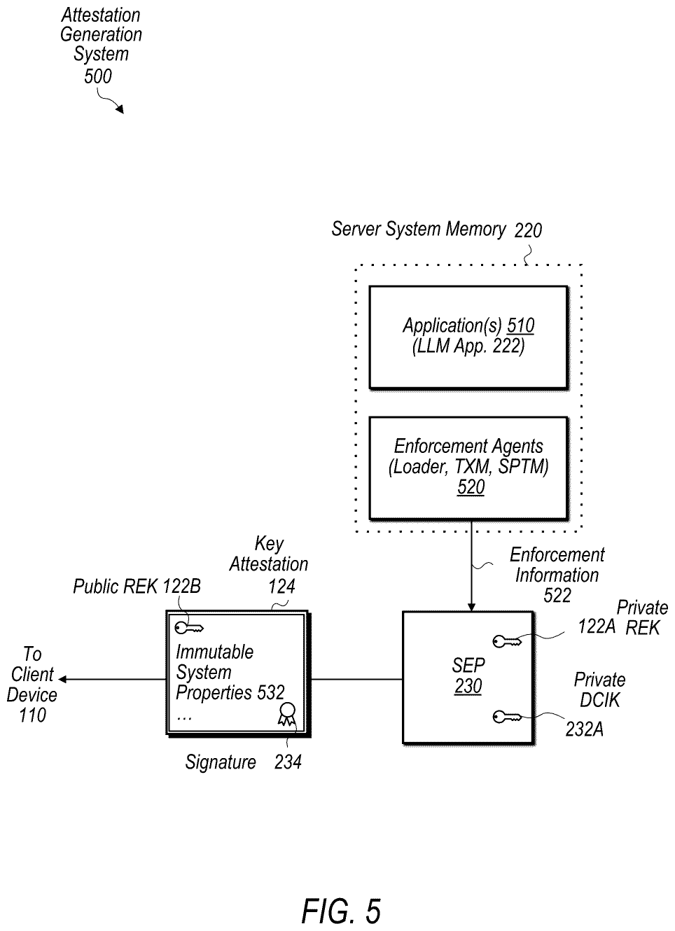

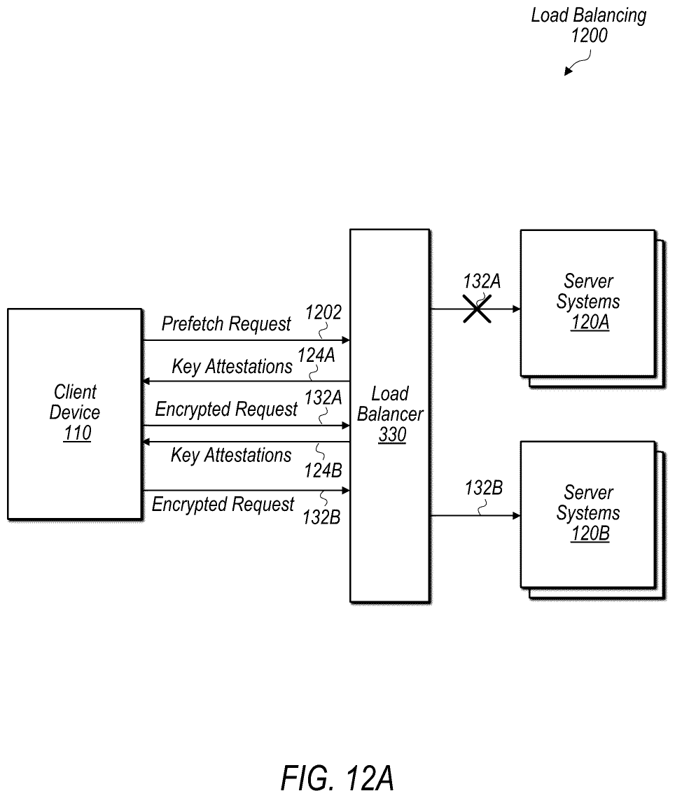

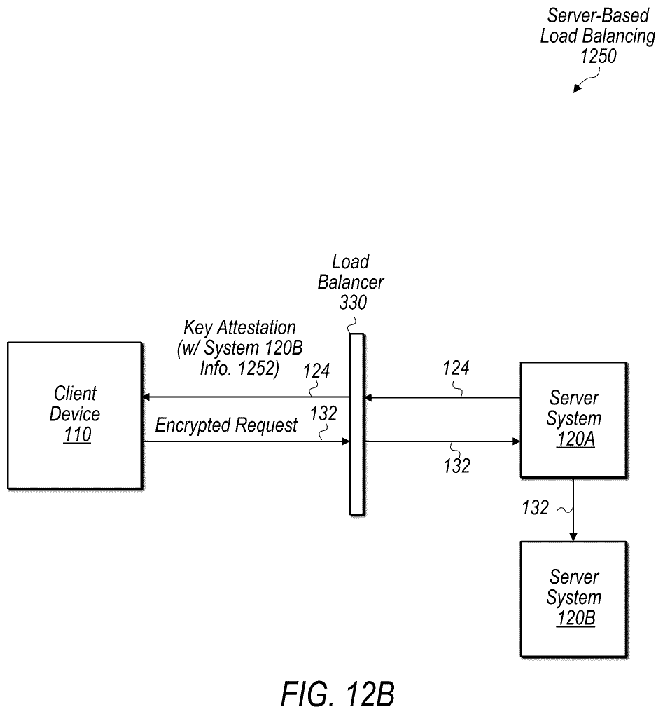

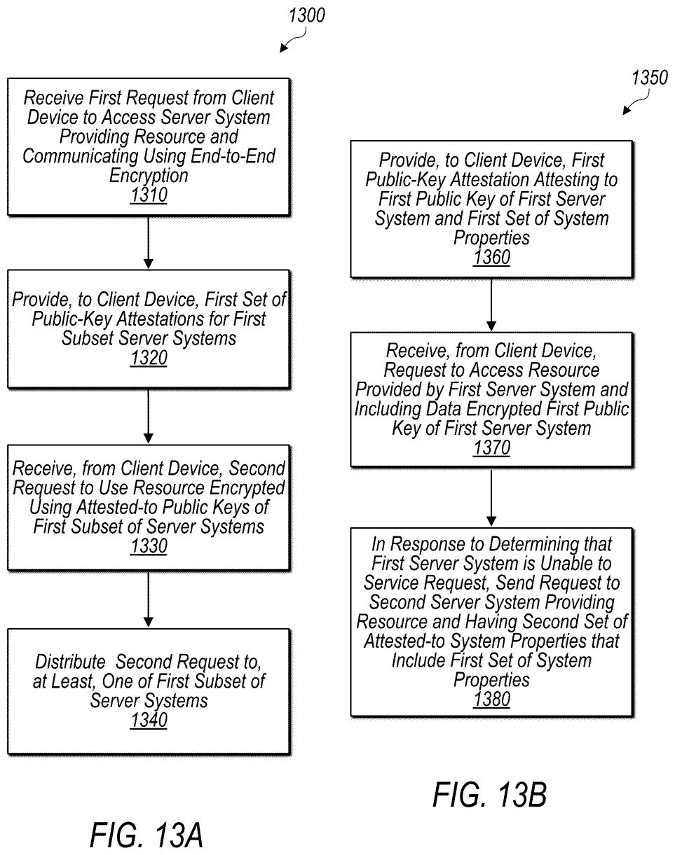

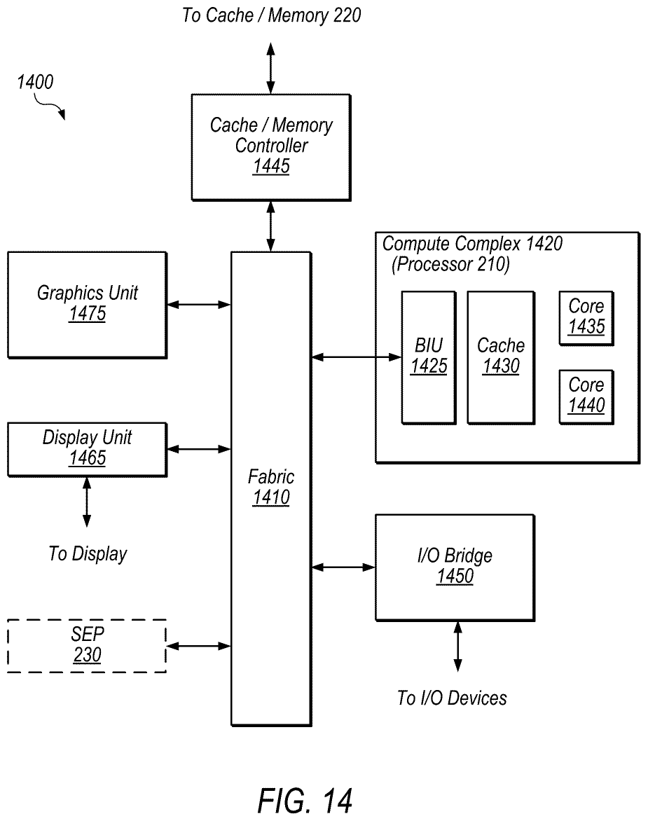

The present disclosure begins, in conjunction with FIGS. 1-4B, describing a system that securely processes LLM requests from a client device to one or more assisting server systems, which may provide public-key attestations usable to secure communication with a client device and may use anonymous tokens to rate limit requests while preserving user privacy. The present disclosure then presents, with FIGS. 5-11B, a discussion of an attestation generation system in which a server system generates a public-key attestation that also attests to immutable system properties that are enforced by components of the server system. A system for load balancing across multiple server systems is then discussed with respect to FIGS. 12A-13B. Exemplary computer system components, which may be used to implement functionality described herein, are lastly discussed in conjunction with FIGS. 14-16.

### LLM Processing System

As ML models, such as LLMs, continue to gain popularity, concerns surrounding user privacy arise. One major concern is the potential for third parties to exploit user data for their own purposes. For instance, when users submit requests to these models, they may inadvertently be sharing personal information that can be used to create targeted advertisements, profile users, etc. Furthermore, the algorithms themselves may not always prioritize user privacy as they are designed to generate results based on patterns and associations in large datasets, which could include prior user requests and responses. This could result in a user's input potentially be used to inform the results for another user's query, blurring the lines between personal and shared information. The lack of transparency around how these models process and store user data also raises questions about accountability and consent. As ML models become increasingly ubiquitous, it is important that developers take greater steps to ensure the responsible handling of sensitive user information.

The present disclosure describes embodiments in which a client device can submit LLM-related requests to assisting server systems in a manner that can preserve user secrecy and user privacy. As will be discussed below in various embodiments, a device can process a query using a locally stored LLM operable to use supplemental data provided by one of a plurality of assisting server systems. In order to communicate securely with the assisting server systems, the device verifies a set of public-key attestations, each attesting to a public key of a respective one of the assisting server systems. Based on the verification being successful, the device sends a request for the supplemental data to the assisting server systems such that the request includes intermediary data produced by the processing and encrypted using the attested-to public keys. The device then processes the received supplemental data using the LL M to produce a result of the query. In such an embodiment, because the device is encrypting the intermediary data directly to an assisting server, any intermediary observer is unable to easily discern the encrypted contents of the request. This can also ensure that the request contents are confined to the boundaries of the assisting servers. Furthermore, because the device may perform, at least, a portion of the LL M work locally and may merely provide intermediary data, the assisting server system may be unable to easily determine the original query's contents.

In some embodiments, a rate limiting system is also employed in which anonymized tokens are used to grant a client device the ability to access to the assisting server systems while also hiding a user's identity to the assisting server systems. In particular, a user of a client device may authenticate to an identity service that can grant the user the ability to access the assisting server systems. The client device may then obtain an anonymized one-time token for receiving access by sending a token request that includes a blind version of the one-time token for signing by the token service and unblinding the signed blind one-time token received from the token service to produce the anonymized one-time token. The client device can then provide the anonymized one-time token with its request for the supplemental data. The assisting server system can then validate the token without ever knowing the user's authentication information—and thus the user's identity, which could be used to associate the user to their various submitted requests.

Turning now to FIG. 1, a block diagram of a system 100 configured to securely process LLM requests is depicted. In the illustrated embodiment, system 100 includes one or more client devices 110 and server systems 120. A client device 110 may further include an LLM client 130. In some embodiments, system 100 may be implemented differently than shown. For example, although various embodiments will be presented in the context of LLMs, use of other types of machines learning models (or other resources) are also contemplated such as large speech to text models, large visual language models (LVLM s), etc.

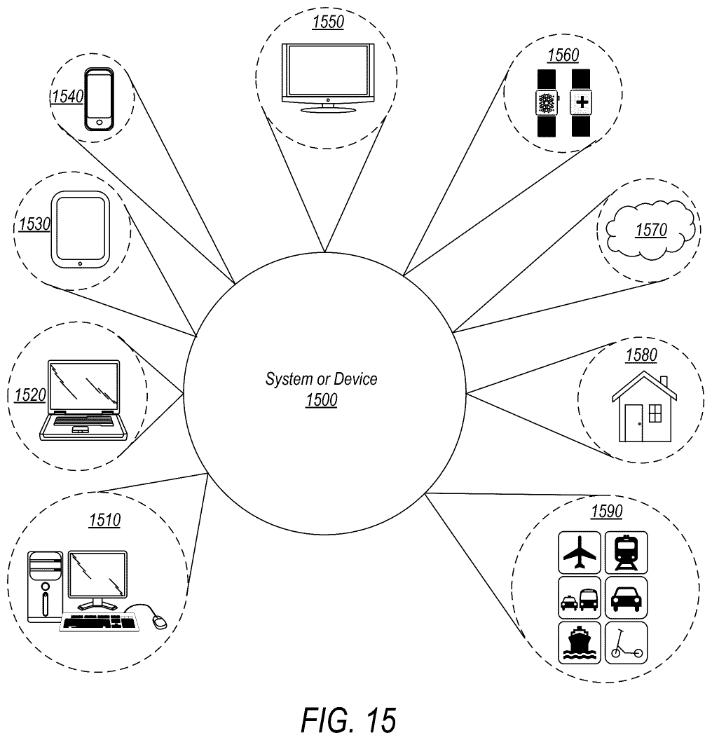

Client device 110 may correspond to any suitable device that can leverage the benefits of LLMs (or other machine learning algorithms) such as a mobile phone, tablet, laptop, personal assistant device, vehicle, or any of the various devices discussed below with respect to FIG. 15. As shown, client device 110 may execute an LLM client that provides access to LLM services, which may be implemented using to any suitable type of LL M such as BERT, GPT, Mistral, LLAMA, or other language models, which may be transformer-based. In some embodiments, LLM client 130 processes a received query 112 using a locally stored LL M operable to use supplemental data 134 provided by an assisting server system 120. LLM client 130 may send a request 132 for the supplemental data 134 to server systems 120 and include intermediary data produced by the processing. In some embodiments, this intermediary data includes one or more embeddings determined by applying the LLM. For example, in one embodiment in which the LLM is based on a transformer model, LLM client 130 applies an encoder of the LLM to query 112 to produce an input for a decoder of the LLM implemented by server systems 120. In some embodiments, processing a query 112 includes applying a tokenization algorithm of the LLM to the query to produce a set of tokens indicative of the query 112 and including the tokens in the intermediary data. In some embodiments in which query 112 is a spoken query, LLM client 130 may convert the speech to text using an ML model and convey the text as intermediary data to server systems 120. In other embodiments, request 132 may merely include the contents of query 112. LLM client 130 may then process the received supplemental data 134 using the LL M to produce a result of the query 112.

Server systems 120 are computer systems that extend device 110's capabilities to operate on much larger data sets with more complex models than would otherwise be possible on device 110. In some embodiments, server systems 120 implement high performance compute (HPC) and may include multiple high performance central processing units (CPU s), graphics processing units (GPUs), neural processing units (NPUs), application-specific integrated circuits (ASICs) or other specialized hardware suitable for processing machine learning tasks. In some embodiments, server systems 120 are accessible via a cloud service that supports client devices 110. As noted above, requests 132 may include sensitive data from client device 110, making it important to secure communication between client device 110 and server systems 120 in order to preserve user privacy. In the illustrated embodiment, server systems 120 provide a set public-key attestations 124 to client devices 110 to secure communication between devices 110 and systems 120.

In the illustrated embodiment, each server system 120 generates a public key pair including and a public request encryption key (REK) 122B and a private REK 122A used to encrypt and decrypt data requests 132, respectively. Public-key attestations 124 are signed data structures that bind public REKs 122B to a corresponding set of information. In some embodiments, public-key attestations 124 are public-key certificates, which may be X.509 compliant. As will be discussed with FIGS. 5-11B, this information may include particular immutable system properties/guarantees enforced by a system 120 to ensure a user's information is processed securely and privately. When a given client 110 receives a server system 120's attestation 124 the client device 110 can verify the attestation 124 including reviewing these system properties. In some embodiments, the client device 110 can also verify the attestation 124 against a separate transparency log that presents additional information about server systems 120. If the verification is successful, a client device 110 can send a request 132 to an assisting server system 120 and include intermediary data produced by LLM client 130 and encrypted using the public REK 122B. The server system 120 can then decrypt request 132 using its corresponding private REK 122A.

As shown, a given client device 110 may receive a set of attestations 124 for multiple server systems 120 and encrypt its request 132 using their attested to public REK s 122B, so that any one of server systems 120 is able to decrypt and service the request 132. In some embodiments, to reduce the cryptographic burden on a client device 110, a client device 110 encrypts its intermediary data with a symmetric key and encrypts a respective instance of the symmetric key with each of the attested-to public REKs 122B. The request 132 can then include the encrypted instances of the symmetric key enabling the server systems 120 to decrypt the encrypted symmetric key using their private REKs 122A and to decrypt the encrypted intermediary data using the symmetric key. As used herein, “using” a cryptographic key to decrypt or encrypt includes 1) decrypting and encrypting with that key, 2) using a key as key material in a key derivation function to derive one or more additional keys used to decrypt or encrypt, or 3) decrypting and encrypting another key used to perform encryption or decryption. Thus, in such an embodiment, the symmetric key and public and private REK s 122 are used to encrypt and decrypt request 132. In some embodiments, a given attestation 124 may also attest to a public REK 122B shared by a cluster of multiple assisting server systems 120. In some embodiments, server systems 120 may also encrypt supplemental data 134 using the symmetric key when providing a response to a request 132.

As will be described next, a given attestation 124 can be generated by using a public key pair maintained by secure hardware included in server systems 120. This secure hardware can resist extraction of the key pair and may limit when a given attestation 124 can be generated. In doing so, the secure hardware may provide an added level of security when systems 120 handle user data in requests 132.

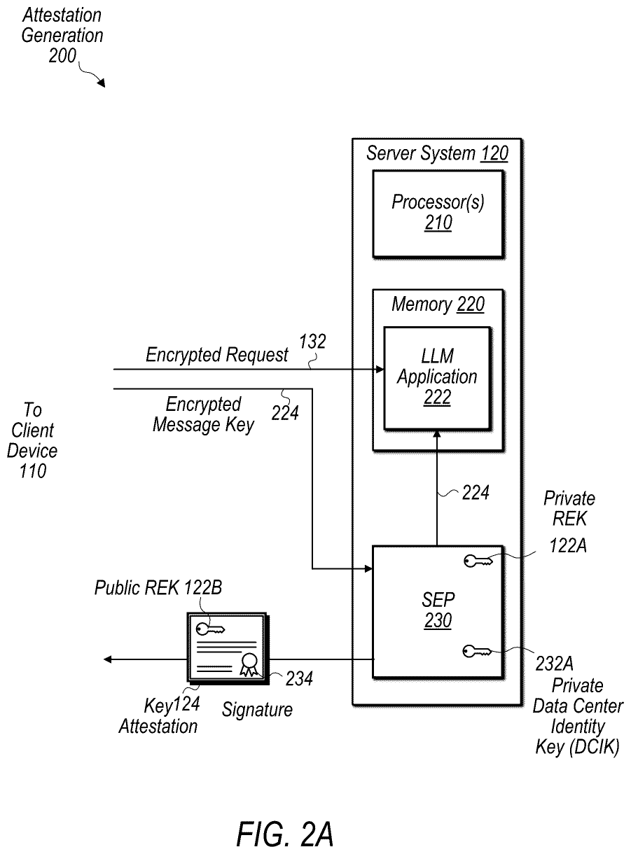

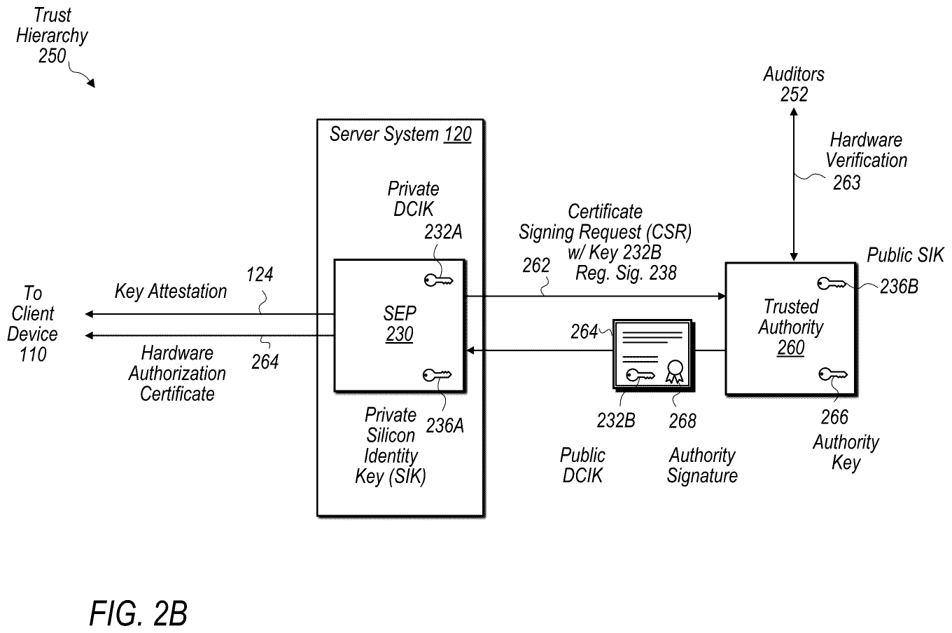

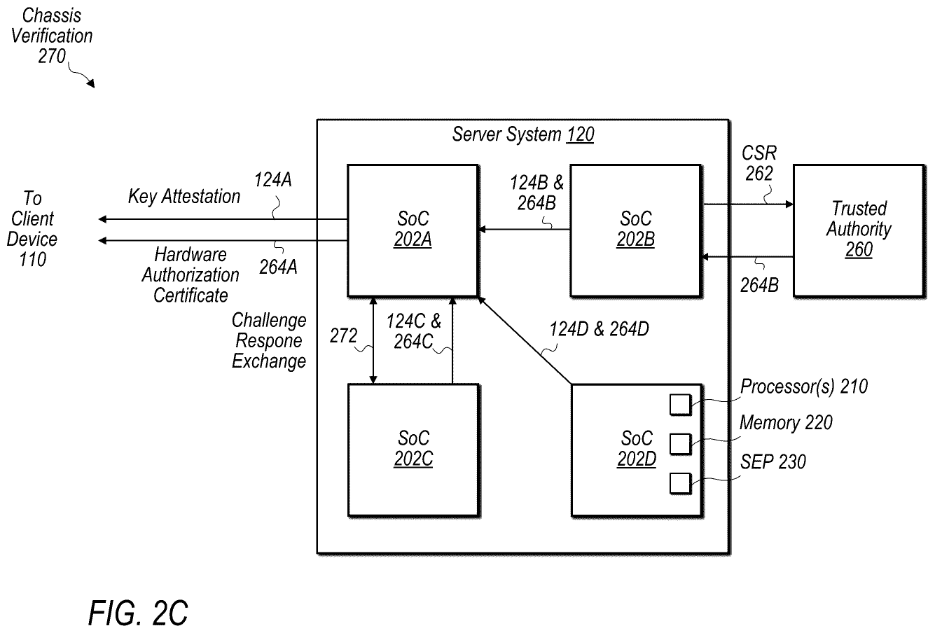

Turning now to FIG. 2A, a block diagram of an attestation generation 200 is depicted. In the illustrated embodiment, server system 120 includes one or more processors 210, memory 220, and secure enclave processor (SEP) 230. Memory 220 further includes an LLM Application 222. In some embodiments, generation 200 may be implemented differently than shown such as incorporating aspects of the generation discussed with FIG. 5.

LLM application 222 is an application that is executable by processors 210 to service requests 132 from client devices 110. Accordingly, application 222 may implement, at least, a portion of an LLM or other resources used to consume intermediary data included in a request 132 and produce a corresponding response including supplemental data 134. In the illustrated embodiment, LLM application 222 decrypts an encrypted request 132 using a symmetric message key 224 included with request 132 and decrypted by SEP 230 using private REK 122A. In other embodiments, LLM application 222 generates and maintains public and private REKs 122, decrypts an encrypted symmetric message key 224 using private REK 122A, and uses the decrypted message key 224 to decrypt encrypted request 132. To add an additional level of security, SEP 230 may be responsible for generating a key attestation 124.

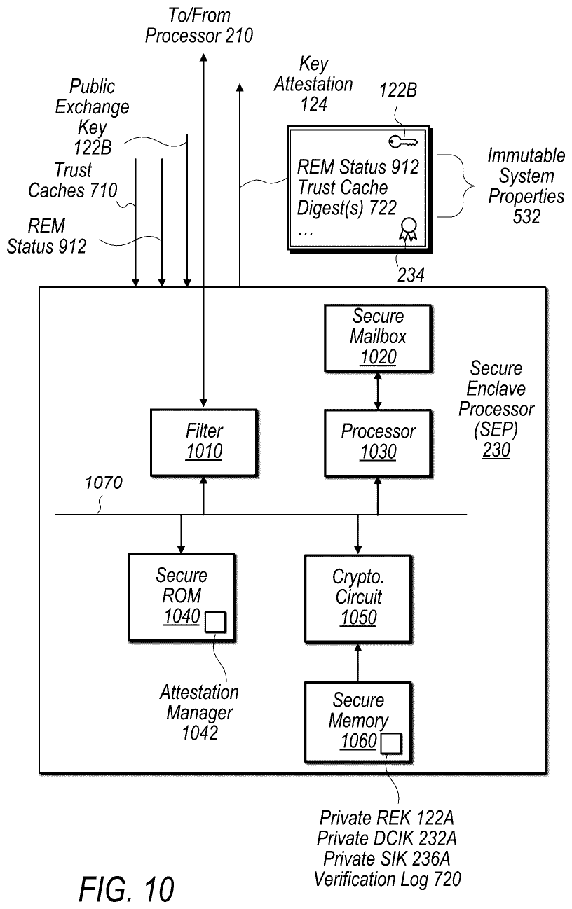

SEP 230 is a secure circuit/hardware configured to perform security sensitive services for server system 120 such as generating and using REKs 122 and generating and signing attestations 124 using a private data center identity key (DCIK) 232A to produce a signature 234 appended to attestation 124. As used herein, the term “secure circuit” refers to a circuit that protects an isolated, internal resource from being directly accessed by an external circuit such as processors 210 and other peripherals. This internal resource may be circuitry that performs services/operations associated with sensitive data such as cryptographic circuitry configured to perform encryption and decryption, key derivation, etc. This internal resource may be memory that stores sensitive data such as a supplied user credential, cryptographic keys, etc. Additionally, in some cases, a secure circuit may be said to be “tamper-resistant,” which is a term of art referring to mechanisms that prevent compromise of the portions of the secure circuit that perform the one or more services. Accordingly, as shown in some embodiments, SEP 230 stores private REK 122A and private DCIK 232A, which may be persisted in an internal memory of SEP 230. As will be described below with respect to FIG. 10, SEP 230 may employ one or more techniques to prevent private REK 122A and private DCIK 232A from being accessible to processors 210 (and thus any malicious executing program instructions) such as the use of a filter, mailbox, secure program instructions, etc.

As will be discussed next, the chain of trust of an attestation 124 may be derived from an authority trusted by client devices 110. To join this chain, SEP 130 may perform an exchange with this trusted authority to obtain authorization to generate attestations 124 used by system 100.

Turning now to FIG. 2B, a block diagram of trust hierarchy 250 for establishing a chain of trust for a public-key attestation 124 is depicted. In the illustrated embodiment, hierarchy 250 includes a trusted authority 260 and SEP 230 in server system 120. In some embodiments, hierarchy 250 may be implemented differently than shown such as relying on a cryptographic key other than silicon identity keys 236, including one or more additional trust authorities attesting to the identity of trusted authority 260, etc.

Trusted authority 260 is a computing system implementing an authority trusted by client devices 110 to reliably authorize server systems 120 to generate attestations 124. In some embodiments, trusted authority 260 is a certificate authority, which may implement a root of trust in hierarchy 250 or be authorized by a higher certificate authority. In some embodiments, trusted authority 260 is trusted, in part, because authority is associated with a manufacturer of server systems 120 and/or client devices 110.

In the illustrated embodiment, SEP 230 requests authorization to generate attestations 124 using a private DCIK 232A by submitting an certificate signing request (CSR) 262 to trusted authority 260. As shown, request 262 includes public DCIK 232B corresponding to private DCIK 232A and is signed using a private silicon identity key (SIK) 236A bound to circuitry within SEP 230. In some embodiments, private and public SIK s 236 are generated and embedded in SEP 230 circuitry during fabrication of server system 120. In some embodiments, SIK s 236 may further be derived using a unique identifier (UID) or generation identifier (GID) stored during fabrication by blowing fuses in a fuse bank within SEP 230. Once derived, public SIK 236B may be stored in a database that is later accessible to trusted authority 260. Although depicted as separate keys 232A and 236A, in some embodiments, functionality of keys 232A and 236A is implemented using a single DCIK, which may be UID derived during fabrication and may self-sign its CSR 262.

In response to receiving a given CSR 262, trusted authority 260 may verify the contents of request 262 including signature 238 using public SIK 236B. In the illustrated embodiment, trusted authority 260 also conducts an extensive hardware verification 263 using information provided from one or more auditors 252. This information may include information collected about the underlying hardware in server system 120 during fabrication such as information about the manufacturing of components 210-230, a manifest identifying particular components 210-230 installed in server system 120, public keys embedded in components during fabrication (such as SEP 230's public SIK 236B), etc. This information may also include information collected from installing server system 120 in a data center such as one or more records generated by auditors 252 confirming that server system 120 was correctly installed. Trust authority 260 may also perform a challenge response exchange with server system 120 to confirm the presence of particular hardware identified in information obtained from auditors 252. This may include providing challenges that include one or more nonces to server system 120 and asking hardware to produce corresponding responses by signing the nonces using private keys such as private SIK 236A. Trusted authority 260 may then verify these responses against information obtained from auditors 252 to ensure that server system 120 has not be modified in an unauthorized manner since fabrication and installation.

Based on these verifications, trusted authority 260 may issue a corresponding hardware authorization certificate 264 indicating that SEP 230 is authorized to generate attestations 124. As shown, hardware authorization certificate 264 includes public DCIK 232B and a signature 268 generated by the authority key 266, which is a private key of the authority 260 and has a corresponding public key known to client devices 110. In some embodiments, certificate 264 also includes information about the hardware installed in server system 120 such as the identifiers of one or more installed hardware components. In some embodiments, certificate 264 is an X.509 certificate, which may identify SEP 230 (or more generally system 120) as an intermediate certificate authority (CA) authorized to issue attestations 124 within trust hierarchy 250. When server system 120 later provides a generated key attestation 124 signed using private DCIK 232A, server system 120 may provide certificate 264 including public DCIK 232B usable to verify signature 234 within the attestation 124 and attesting to the authority of SEP 230/server system 120 to issue attestations 124. Accordingly, in response to receiving an attestation 124 and a certificate 264, a client device 110 may then verify attestation 124 using certificate 264 issued by trusted authority 260.

Although a single certificate 264 has been discussed thus far with respect to a given a server system 120, trust authority 260 may issue multiple certificates 264 to individual hardware components, such as individual system-on-a-chips (SoCs) within system 120, each capable of generating their own attestations 124.

Turning now to FIG. 2C, a block diagram of a chassis verification 270 is depicted. In the illustrated embodiment, server system 120 includes multiple SoCs 202A-D, each with a respective set of processors 210, memory 220, and SEP 230. In various embodiments, SoCs 202 are mounted on a motherboard within a chassis of server system 120 and interconnected via one or more highspeed busses, which may be implemented using peripheral component interconnect (PCI) express, for example.

As shown, each SoC 202 (or more specifically each SEP 230 in each SoC 202) may send a respective CSR 262 to obtain a corresponding hardware authorization certificate 264 indicating that the particular SoC 202 is authorized to issues attestations 124. Because this can greatly increase the number of attestations 124 and certificates 264 for verification by a client device 110, server system 120, instead, performs a chassis verification 270, in the illustrated embodiment, in which a designate one of the SoCs 202A performs a verification of the other SoCs 202B-D's attestations 124B-D and certificates 264B-D. In the illustrated embodiment, this verification includes performing a challenge response exchange 272 with each of the other SoCs 202B-D in which SoC 202A provides a respective nonce to each SoC 202B-D and asks that SoC 202B-D to have its SEP 230 sign the respective nonce using its Private REK 122A and/or Private DCIK 232A. SoC 202A may then verify their signature responses using the public keys 122B and 232B in their attestations 124 and certificates 264. If this verification is successful, the SoC 202A provides its key attestation 124A and hardware authorization certificate 264A on behalf of server system 120 as a whole. Thus, in the illustrated embodiment, a given client device 110 can verify only one attestation 124A and one certificate 264A for a given server system 120 at a given time. Because a given client device 110 may possess only SoC 202A's public REK 122B, however, SoCs 202 may employ a load balancing scheme similar to the server-based load balancing scheme discussed below with respect to FIG. 12B in which server system 120A and server system 120B are replaced with SoC 202A and SoCs 202B-C.

As will be discussed next, a rate limiting system may be employed to ensure that server systems 120 are not overwhelmed by client requests 132. This system may authenticate users/client devices 110 in order to ensure that only authenticated users/client devices 110 are able to submit requests 132. Because this authentication may be used to associate users with their requests 132, however, the rate limiting system may provide anonymized tokens to client devices 110 to disassociate a user's authentication information with their requests 132. In some embodiments, these tokens are anonymized using blind signatures.

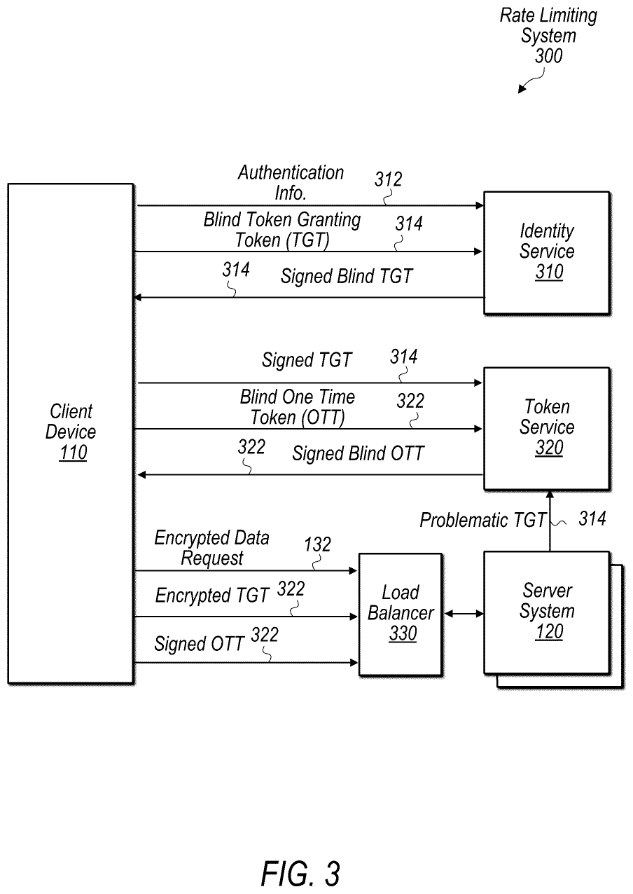

Turning now to FIG. 3, a block diagram of a rate limiting system 300 is depicted. In the illustrated embodiment, system 300 includes an identity service 310, token service 320, and load balancer 330. In some embodiments, system 300 may be implemented differently such as omitting one or more of components 310-330, using more (or fewer) tokens, etc.

Identity service 310 is a server system responsible for authenticating a client device 110/user to prevent unauthorized devices from submitting requests 132 to server systems 120. As shown, client device 110 may provide authentication information 312 to identity service 310 as part of an authorization request for a token granting token (TGT) 314 that authorizes device 110 to receive one-time tokens (OTT) 322. Authentication information 312 may include any suitable form of authentication information such as a username, password, digital signature, etc. In order to anonymize TGT 314, in the illustrated embodiment, device 110 also includes, in its authorization request, a blind version of the TGT 314 generated by blinding TGT 314 using a blind signature algorithm. In response to successful verification of the authentication information 312, identity service 310 signs the blind TGT 314 and returns the signed blind TGT 314 to client device 110, which then unblinds the signed TGT 314 preventing identity service 310 (or any other entity) from associated the signed TGT 314 with authentication information 312. Client device 110 may then provide this unblind signed TGT 314 to token service 320.

Token service 320 is a separate server system responsible for limiting how frequently a device 110 can submit requests 132 by issuing OTTs 322, each authorizing a client device 110 to submit a single request 132. In the illustrated embodiment, device 110 requests a signed OTT 322 by initially providing a blind version of the OTT 322 generated by blinding OTT 322 using the blind signature algorithm. In response to successful verification of the signed TGT 314, token service 320 signs the blind OTT 322 and returns the signed blind OTT 322 to client device 110, which then unblinds the signed OTT 322 preventing token service 320 (or any other entity) from associated the signed OTT 322 with its TGT 314—and thus other OTTs 322 obtained using the TGT 314. In some embodiments, client device 110 may provide a batch of multiple blind OTTs 322 for signature, so that device 110 have multiple signed OTTs 322 available for use without having to contact service 320 each time an OTT 322 is needed. When client device 110 later wants to send an encrypted data request 132 to server systems 120, device 110 may provide the request 132 along with an unblind OTT 322 and its TGT 314, which may be encrypted using public REK s 122B of the server systems 120. In the illustrated embodiment, device 110 initially communicates this information to load balancer 330.

Load balancer 330 is network hardware responsible for distributing workloads across server systems 120. In some embodiments, load balancer 330 verifies a received signed OTT 322 before forwarding encrypted data request 132 and encrypted TGT 314 in order to avoid burdening a given server system 120 if an OTT 322 is invalid. In the illustrated embodiment, the TGT 314 provided with a request 132 is encrypted to prevent the load balancer 330 from associating it with multiple requests 132 but is also provided as a way for a given server system 120 to revoke a client device 110's ability to receive subsequent OTTs 322 if client device 110 has created a problematic request 132. For example, server system 120 may determine that a particular request 132 results in a crash or some other adverse outcome, which may suggest that device 110 has been compromised. In order to prevent the client device 110 from making similar requests 132 in the future, server system 120 may decrypt the encrypted TGT 314 and flag it to token service 320 as a problematic TGT 314 to cause token service 320 to discontinue signing OTTs 322 for that TGT 314. In some embodiments, load balancer 330 further communicates with client device 110 via a proxy server that obfuscates an internet protocol (IP) address of client device 110 in order to prevent load balancer 330 from associating requests 132 with its IP address.

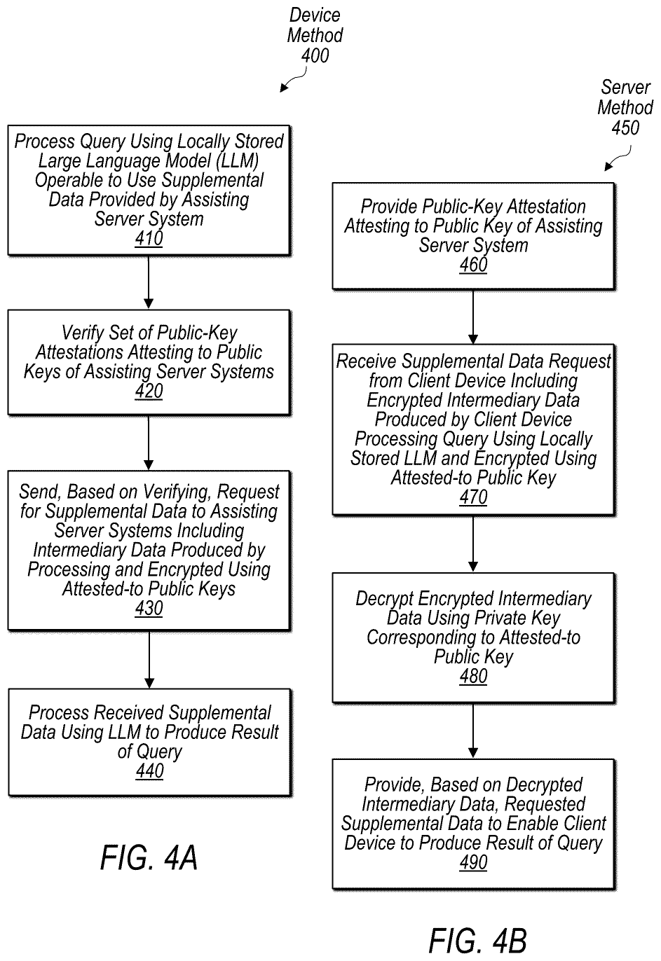

Turning now to FIG. 4A, a flow diagram of a device method 400. Method 400 is one embodiment of a method performed by a device, such as client device 110, to communicate securely with one of multiple server systems, such as server systems 120.

Method 400 begins in step 410 with a device processing a query (e.g., query 112) using a locally stored large language model (LLM) operable to use supplemental data (e.g., supplemental data 134) provided by one of a plurality of assisting server systems. In step 420, the device verifies a set of public-key attestations (e.g., attestations 124), each attesting to a public key (e.g., public REK 122B) of a respective one of the assisting server systems. In step 430, the device sends, based on the verifying, a request (e.g., request 132) for the supplemental data to the assisting server systems, the request including intermediary data produced by the processing and encrypted using the attested-to public keys. In step 440, the device processes the received supplemental data using the LLM to produce a result of the query.

Turning now to FIG. 4B, a flow diagram of a server method 450. Method 450 is one embodiment of a method performed by an assisting server system, such as server system 120, to communicate securely with one or more client devices, such as devices 110.

Method 450 begins in step 460 with a server system assisting in large language model (LL M) processing providing a public-key attestation (e.g., attestation 124) attesting to a public key (e.g., public REK 122B) of the assisting server system. In step 470, the server system receives a request (e.g., request 132) from a client device to provide supplemental data (e.g., supplemental data 134), the request including encrypted intermediary data produced by the client device processing a query using a locally stored LLM and encrypted using the attested-to public key. In step 480, the server system decrypts the encrypted intermediary data using a private key (e.g., private REK 122A) corresponding to the attested-to public key. In step 490, the server system provides, based on the decrypted intermediary data, the requested supplemental data to enable the client device to produce a result of the query.

### Attesting to Immutable Properties

In order to ensure that a server system maintains secrecy and user privacy, it is important to have detailed knowledge of both the hardware and software currently present on the system such as knowing which components are installed, their configurations, and what software applications are authorized to execute on the system. Relying solely on an operating system (OS) to handle these tasks assumes that the OS is trustworthy, but this assumption can be problematic. If the OS itself is ever compromised, the entire system cannot be relied upon to convey accurate information about its own state, rendering any trust in it misplaced. It is thus important to find an alternative way to monitor and verify the system's components and software outside of the domain of the OS to ensure that they are functioning securely and transparently.

The present disclosure describes embodiments in which a server system provides a public-key attestation that also attests to immutable system properties enforced by the server system. As will be described below in various embodiments, a server system can provide a resource accessible to multiple client devices using end-to-end encryption. In some embodiments, this resource may include the LLM (or LLM application 222) discussed above; in other embodiments, however, this resource may be particular hardware, particular applications, other ML models, etc. The server system can provide a signed attestation that attests to a public key of the server system as well as a set of system properties of the server system that are immutable while the resource is accessible. These immutable system properties can include identifying a set of applications authorized to execute while the resource is accessible, identifying particular hardware used to provide the resource, identifying particular configuration information, identifying operating system information, or any other suitable metrics. To ensure that these system properties are immutable, in some embodiments, the server system executes one or more enforcement agents that work outside of the OS domain to enforce these properties. As will be discussed, this enforcement can include entering a restriction execution mode in which execution of applications is tightly controlled to prevent any unauthorized executions. Enforcement agents may also communicate information via a secure communication channel with the SEP that generates the attestation, so that the SEP can ensure the immutable system properties are being enforced when it signs the attestation. In various embodiments, the server system also publishes information about the immutable system properties to a transparency log stored in a separate transparency server accessible to the client device. The client device can then review this information when validating the server system's attestation. With this knowledge in hand, a user of a client device can confidently know how a server system will behave when it processes information from the user, which may include confidential information.

Turning now to FIG. 5, a block diagram of a system 500 for generation an attestation 124 attesting to immutable properties is depicted. In the illustrated embodiment, server system 120 continues to include a processor 210, memory 220, and SEP 230. Memory 220 now includes one or more applications 510, which may include LLM application 222 discussed above. Memory 220 also includes one or more enforcement agents 520. In some embodiments, system 500 may be implemented differently than shown such as enforcement agents 520 including one or more hardware agents not located in memory 220.

Applications 510 are a set of applications authorized to execute on a server system 120 and may include those executable to use REK s 122 to secure communication with client devices 110 such as LLM application 222 discussed above. In some embodiments, applications 510 may correspond to resources provided by server system 120 or may provide access to resources such as particular hardware accelerators (e.g., GPUs, NPUs, ASICs, etc.), particular peripherals, particular input/output devices, ML models, etc. As noted above, a client device 110 interfacing with an application 510 may want to receive information about a server system 120 including certain guarantees about how the server system 120 will behave when processing received requests 132 to access resources associated with applications 510. In the illustrated embodiment, SEP 230 signs this information into a key attestation 124 in the form of immutable systems properties 532.

Immutable system properties 532 are a set of system properties that are immutable while a resource is accessible to client devices 110. In various embodiments, immutable system properties 532 identify an enforced set of applications 510 authorized to execute while the resource is accessible. For example, in some embodiments discussed below, immutable system properties 532 identify applications 510 by including signed digests generated from hashing program instructions of the authorized applications 510. In some embodiments, immutable system properties 532 includes one or more indications of particular hardware included in server system 120 (and used to provide the resource) such as a unique device identifier, a unique processor identifier, an indication of the presence of SEP 230, etc. In some embodiments, immutable system properties 532 include configuration information, various metrics collected about an OS of server system 120, etc. In some embodiments, immutable system properties 532 identify whether system 120 has entered into one or more particular modes such as an ephemeral data mode in which system 120 guarantees to not persist application data in non-volatile memory between system reboots, a restriction execution mode, a developer mode, etc.

Enforcement agents 520 are a collection of components responsible for ensuring that system properties 532 are immutable. As shown, enforcement agents 520 may also provide enforcement information 522 usable by SEP 230 to confirm that immutable system properties 532 are being enforced. As will be discussed in greater in subsequent figures, enforcement agents 520 may include a loader responsible for providing signed manifests of code hashes to SEP 230, a trust execution monitor (TXM) responsible for authorizing execution of applications 510, and a secure page table monitor (SPTM) responsible for managing system 120's page table that identifies mappings of virtual addresses to physical addresses. In various embodiments, some enforcement agents 520, such as TXM and SPTM, are distinct components from the OS of server system 120 and may execute at a higher privilege level than that of the OS kernel ensuring that these components are not preempted by the kernel and can access regions of memory 220 that are inaccessible to the kernel. In some embodiments, information about enforcement agents 520 including information about the immutable system properties 532 is published to a transparency log stored in a transparency server accessible to client device 110 for verifying signed attestation 124.

As will be discussed, part of enforcement of immutable system properties 532 can include server system 120 entering a restricted execution mode (REM) in which server system 120 executes only a set of authorized applications. As part of entering REM, server system 120 deallocates portions of memory 220 assigned to user space to clear user space of application data associated with applications 510 executing prior to entering the REM and, after the deallocating, initiates execution of only ones of the set of applications 510 authorized to execute during the REM. Applications 510 authorized to execute during the REM may then store data in the cleared user space.

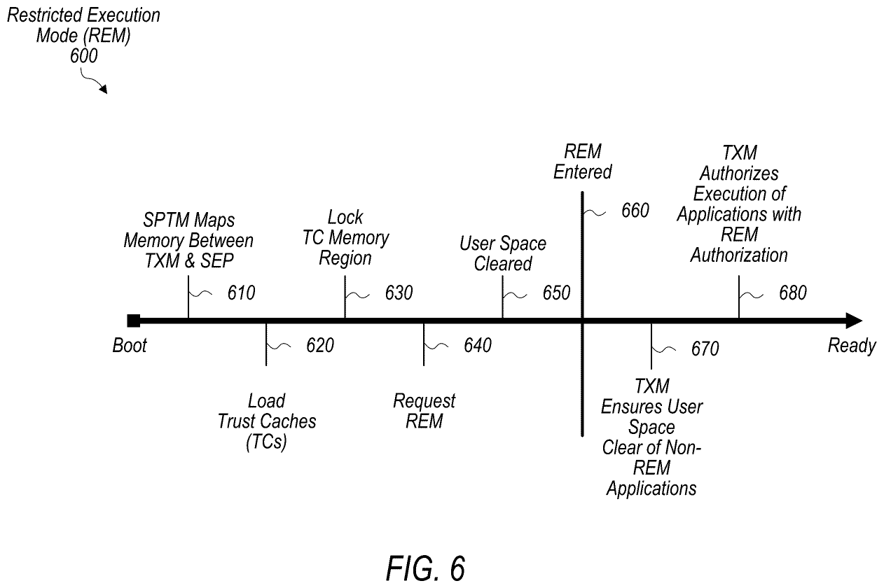

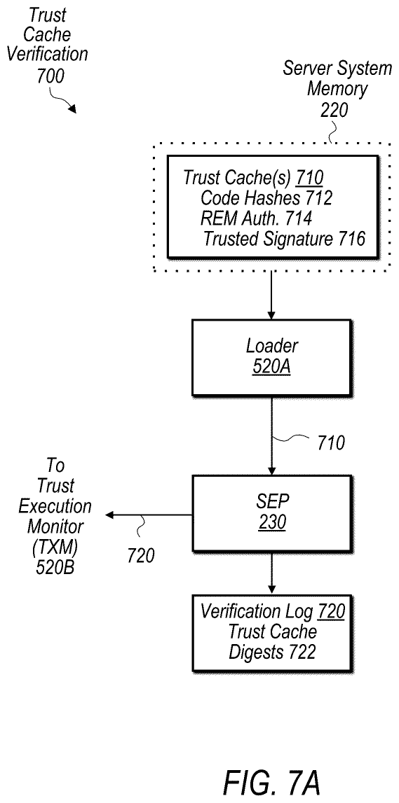

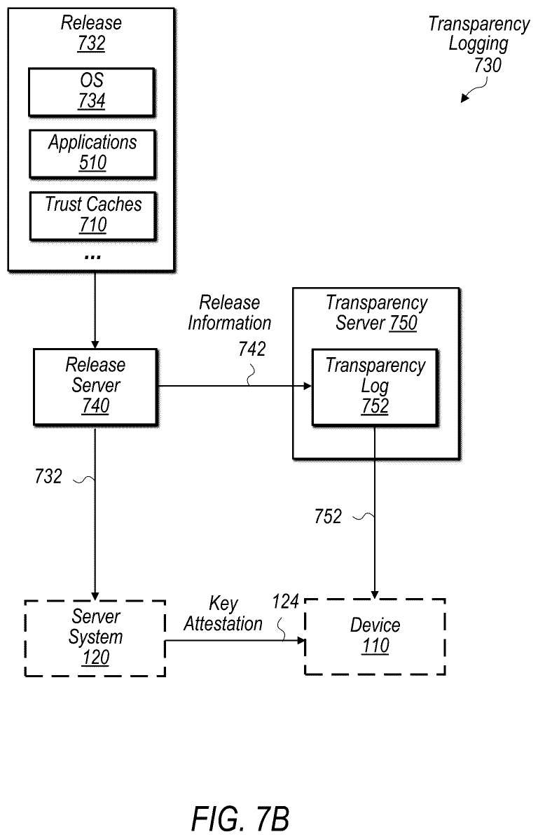

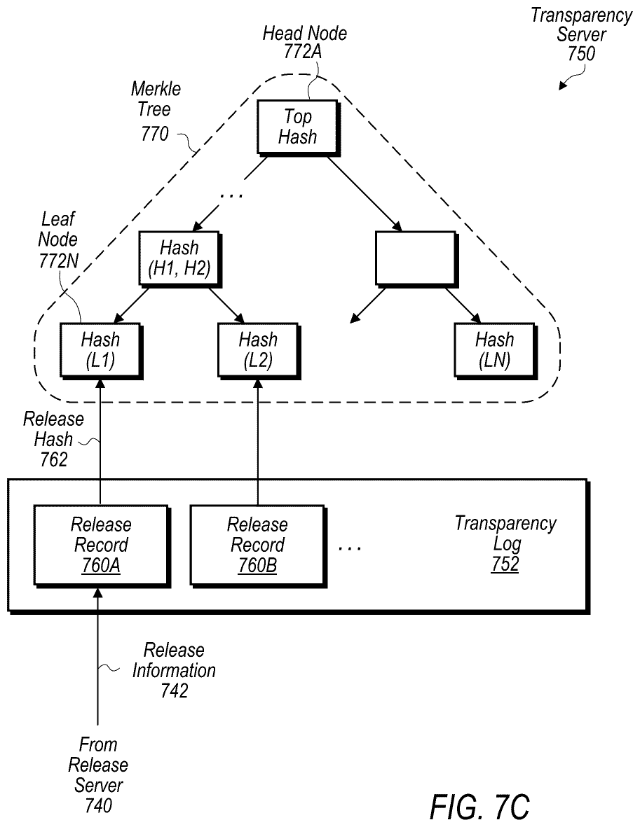

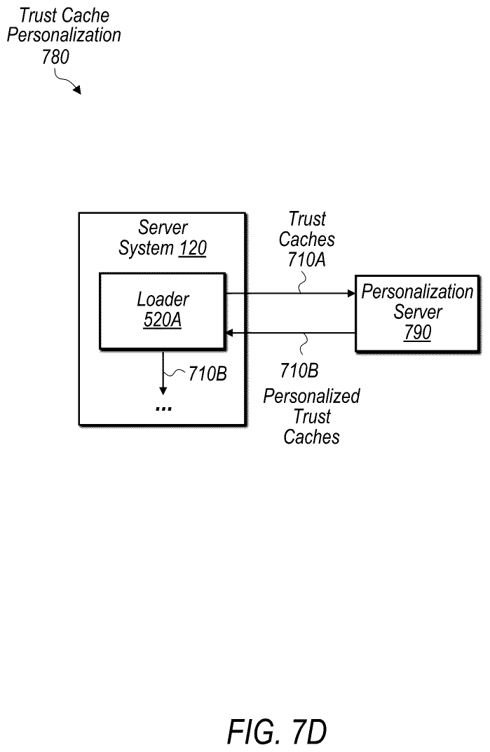

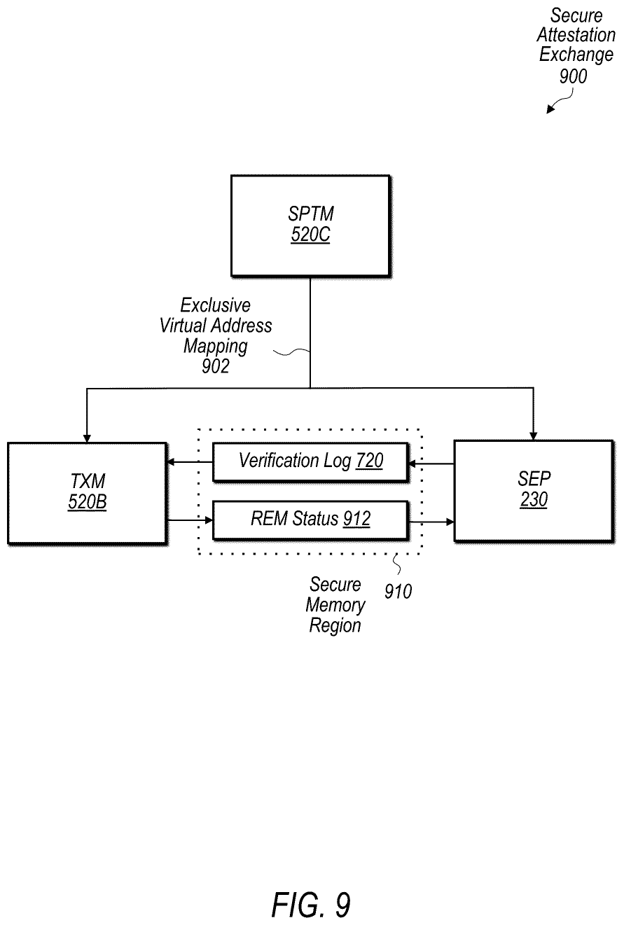

Turning now to FIG. 6, a timeline diagram for enabling a restricted execution mode 600 is depicted. As shown, the timeline may begin with server system 120 performing a boot process in which system 120 becomes initialized and begins executing its operating system. At 610, the SPTM maps a region of memory 220 between the TXM and SEP 230. In some embodiments, this includes the SPTM providing virtual address mappings of the memory region to the TXM and SEP 230 giving them exclusive access to write to the memory region. As will be discussed with FIG. 9, this may be used as a secure memory channel to facilitate communication between the TXM and SEP 230. At 620, a loader of server system 120 loads a set of trust caches (TC), which are signed manifests identifying code hashes generated from program instructions of applications 510 authorized to execute on server system 120 as will be discussed next with FIG. 7A. At 640, a request is made to enter REM, which causes user space to be cleared at 650. Server system 120 then transitions into REM at 660. At 670, the TXM ensures user space remains cleared of all non-REM applications 510—i.e., those that lack authorization to execute in REM.

Turning now to FIG. 7A, a block diagram of a trust cache verification 700 is depicted. In the illustrated embodiments, verification 700 includes a loader 520A receiving a set of trust caches 710 for applications 510. As shown, a given trust cache 710 for an application 510 can include code hashes 712 generated from hashing program instructions of the application 510, a REM authorization 714 indicating whether the application 510 is authorized to run before and/or after server system 120 enters REM, and a trusted signature 716 generated by signing trust cache 710 to preserve its integrity. In some embodiments, trusted signature 716 is created by a trusted source such as a manufacture of server system 120, developer of application 510, etc.

In various embodiments, loader 520A is a set of program instructions executable to load an application 510 into a file system of server system 120—thus making the application 510 available for execution. As part of loading an application, loader 520A reads trust caches 710 from memory 220 and provides them to SEP 130 for verification. In some embodiments, loader 520A may be implemented by an installer, a boot loader, a package manager, etc.

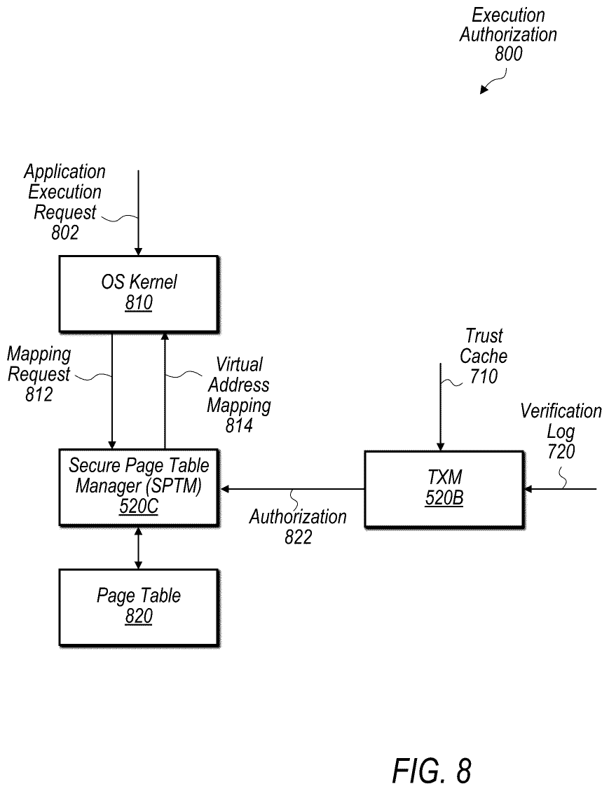

In response to receiving trust caches 710, SEP 230 may then verify their signatures 716 to confirm that they have not been tampered with. As SEP 230 verifies trust caches 710, SEP 230 records a hash of the trust cache 710, shown as a trust cache digest 722, in a verification log 720. This verification log 720 may thus serve as an indication of what applications 510 are authorized to execute on system 120. SEP 230 may also provide log 720 to TXM 520B, which examines the log when determining whether to authorize execution of an applications 510 as will be discussed with FIG. 8.

Trust caches 710 may be obtained as part of a packaged release that is downloaded by a server system 120 from a release server. Information about this release may be recorded in a transparency log accessible to client devices 110 or other security auditors as will be discussed next.

Turning now to FIG. 7B, a block diagram of transparency logging 730 is depicted. As new software is developed for server systems 120, this software may be packaged in a new release 732, which is provided to a release server 740 for distribution to server systems 120. As shown, a given release 732 can include, for example, an operation system (OS) 734, applications 510, and trust caches 710 including the code hashes 712 for OS 734 and applications 510. In some embodiments, a given release 723 may include additional program instructions and corresponding trust caches 710 such as program instructions for enforcement agents 520, various drivers, etc. In the illustrated embodiment, information 742 about a given release 732 is provided to a transparency server 750 for storage in a transparency log 752.

Release server 740 may provide any suitable information 742 for storage in log 752. For example, information 742 may include information about the immutable system properties 532 such as information about one or more components within server systems 120, information about OS 734 executing on server systems 120, information about applications 510, trust caches 710 (or trust cache digests 722), etc. In general, transparency log 752 may serve as an additional source of information about server systems 120 and may contain additional information not present in attestations 124. As shown, a client device 110 may later access transparency log 752 as it verifies a key attestation 124 to leverage the information stored in log 752.

Turning now to FIG. 7C, a block diagram of various components of the transparency log 752 within transparency server 750 is depicted. As shown, transparency log 752 include multiple release records 760 including release information 742 received from release server 740. In the illustrated embodiment, transparency log 752 is implemented as an appended-only log using a Merkle tree 770. Accordingly, as records 760 are appended to transparency log 752, a corresponding leaf node 772 may be appended to tree 770 by applying a hash function (e.g., SHA-256) to the record 760 to produce a release hash 762. For example, record 760A (abbreviated as L1 in tree 770) may be hashed to produce leaf node 772N including a hash value shown as H1. Similarly, record 760B (abbreviated as L2 in tree 770) may be hashed to produce another sibling leaf node 772 including a hash value H2. As leaf nodes 772 are appended to tree 770, the hash values (e.g., H1 and H2) in sibling nodes 772 may be concatenated and then hashed to produce the hash value included in the parent node 772. This process may continue until a head node 772A is produced, which is dependent on all the hash values in lower nodes 772. If the integrity of a record 760 is later questioned, its integrity can be verified by verifying the hash values along the path from its corresponding leaf node 772 to the map head node 772A and the hash values in the corresponding sibling nodes 772 of those nodes 772 residing along the path.

Turning now to FIG. 7D, a block diagram of trust cache personalization 780 is depicted. In the illustrated embodiment, as part of loading trust caches 710, loader 520A initially provides them to personalization server 790 to cause the trust caches 710 to be personalized to server system 120 in order to prevent them from being used on another server system 120 to authorize execution of applications 510. This may generally include inserting various information into trust caches 710B that is unique to a particular server system 120 such as particular identifiers for hardware present in server system 120, unique values associated with a server system 120, etc. Server 790 may then resign this modified trust caches 710B and provide them back to server system 120 for storage. When loader 520A attempts to load the software corresponding trust caches 710B, SEP 130 may confirm that the personalized information in trust caches 710B correctly corresponds to its server system 120 before execution can be granted.

Turning now to FIG. 8, a block diagram of an execution authorization 800 is depicted. As shown, an OS kernel 810 may receive a request 802 to authorize execution of an application 510. Because OS kernel 810 does not manage its own page table 820, in the illustrated embodiment, OS kernel 810 sends a mapping request 812 to SPTM 520C for a virtual address mapping 814 indicating where the application 510 can store its data once execution begins. Before granting this request, however, SPTM 520C may ask TXM 520B to confirm whether the application 510 has been authorized for execution by one of trust caches 710. In response to receiving this request, TXM 520B may read the corresponding trust cache 710 and confirm that a digest 722 is present in log 720 indicating that SEP 230 has already verified the corresponding trust cache 710. If the digest 722 is present and the trust cache 170 includes REM authorization 714 indicating that the application 510 can currently execute, TXM 520B provides an authorization 822 to SPTM 720C. In response, SPTM 520C may update page table 820 and provide a virtual address mapping 814 for use by the application 510 enabling it to access a region of memory 220—and thus execute.

Turning now to FIG. 9, a block diagram of an attestation generation exchange 900 is depicted. As noted above with FIG. 6 and depicted in FIG. 8, SPTM 520C may provide an exclusive virtual address mapping 902 to TXM 520B and SEP 230 identifying a memory region 910 accessible to TXM 520B and SEP 230. In the illustrated embodiment, SPTM 520C exclusively provides this mapping to TXM 520B and SEP 230 such that they are the only ones authorized to write this region 910. This mapping 902 may further being enforced by memory controllers associated with processor 210 and SEP 230. As a result, TXM 520B and SEP 230 can exchange information via this secure memory region 910 such as verification log 720 and REM status 912 indicating whether the server system 120 has currently entered REM, which SEP 230 may include in attestation 124. Because other components, such as kernel 810, do not have the mapping 902 enabling them to access this region, compromised software, such as kernel 810, cannot interfere with the communications of TXM 520B and SEP 230. In some embodiments, additional secure memory regions 910 may be allocated to allow other enforcement agents 520 to communicate other enforcement information 522 with SEP 230.

Turning now to FIG. 10, a block diagram of SEP 230 is depicted. In the illustrated embodiment, SEP 230 includes a filter 1010, secure mailbox mechanism 1020, processor 1030, secure ROM 1040, cryptographic circuit 1050, and secure memory 1060 coupled together via an interconnect 1070. In some embodiments, SEP 230 may include more (or less) components than shown in FIG. 10. As noted above, SEP 230 is a secure circuit, which may have tamper resistance. As discussed below, SEP 230 implements tamper resistance through the use of filter 1010 and secure mailbox 1020.

Filter 1010 is circuitry configured to tightly control access to SEP 230 to increase the isolation of the SEP 230 from the rest of system 120, and thus the overall security of system 120. More particularly, in some embodiments, filter 1010 may permit read/write operations from processors 210 (or other external peripherals in some embodiments) to enter SEP 230 only if the operations address the secure mailbox 1020. Other operations may not progress into SEP 230. Even more particularly, filter 1010 may permit write operations to the address assigned to the inbox portion of secure mailbox 1020, and read operations to the address assigned to the outbox portion of the secure mailbox 1020. All other read/write operations may be prevented/filtered by the filter 1010. In some embodiments, filter 1010 may respond to other read/write operations with an error. In one embodiment, filter 1010 may sink write data associated with a filtered write operation without passing the write data on to local interconnect 1070. In one embodiment, filter 1010 may supply nonce data as read data for a filtered read operation. Nonce data (e.g., “garbage data”) may generally be data that is not associated with the addressed resource within the SEP 230. Filter 1010 may supply any data as nonce data (e.g. all zeros, all ones, random data from a random number generator, data programmed into filter 1010 to respond as read data, the address of the read transaction, etc.). Thus, filter 1010 may prevent direct access to internal components 1030-1060 by an external entity such as processors 210.

In various embodiments, filter 1010 may only filter incoming read/write operations. Thus, the components of the SEP 230 may have full access to the other components of system 120 such as memory 220. Accordingly, filter 1010 may not filter responses that are provided in response to read/write operations issued by SEP 230.

Secure mailbox 1020 is circuitry that, in some embodiments, includes an inbox and an outbox. Both the inbox and the outbox may be first-in, first-out buffers (FIFOs) for data. The buffers may have any size (e.g. any number of entries, where each entry is capable of storing data from a read/write operation). Particularly, the inbox may be configured to store write data from write operations sourced from processor 210. The outbox may store write data from write operations sourced by processor 1030. (As used herein, a “mailbox mechanism” refers to a memory circuit that temporarily stores 1) an input for a secure circuit until it can be retrieved by the circuit and/or 2) an output of a secure circuit until it can be retrieved by an external circuit.)

In some embodiments, software executing on processors 210 (or other external peripherals) may request services of SEP 230 via an application programming interface (API)—i.e., a requester may make API calls that request services of SEP 230. These calls may cause corresponding requests to be written to mailbox mechanism 1020, which are then retrieved from mailbox 1020 and analyzed by processor 1030 to determine whether it should service the requests. Accordingly, this API may be used to send, via mailbox 1020, for example, send trust caches 710 for verification as well as send a request to generate a key attestation 124 including sending its contents for signature such as public exchange key 122B, REM 912 status, etc. By isolating SEP 230 in this manner, integrity of SEP 230 may be enhanced-including preventing, for example, a malicious process running on processors 210 from extracting private REK 122A, private DCIK 232A, and private SIK 236A.

SEP processor 1030 is configured to process commands received from various sources in server system 120 and may use various secure peripherals to accomplish the commands. Processor 1030 may then execute instructions stored in ROM 1040 (or elsewhere such as memory 220) such as attestation manager 1042, which may facilitate verification of trust caches 710, generating of a key attestation 124, or other functionality described herein with respect to SEP 230. For example, SEP processor 1030 may execute key manager 1042 to provide appropriate commands to cryptographic circuit 1050 to validate signatures in trust caches 710, generate digests 722, sign immutable properties such as REM status 912 and digests 722, etc.

Secure ROM 1040 is a memory configured to store program instruction for booting SEP 230. In some embodiments, ROM 1040 may respond to only a specific address range assigned to secure ROM 1040 on local interconnect 1070. The address range may be hardwired, and processor 1030 may be hardwired to fetch from the address range at boot in order to boot from secure ROM 1040. Filter 1010 may filter addresses within the address range assigned to secure ROM 1040 (as mentioned above), preventing access to secure ROM 1040 from components external to the SEP 230. In some embodiments, secure ROM 1040 may include other software executed by SEP processor 1030 during use. This software may include the program instructions to process inbox messages and generate outbox messages, etc. In some embodiments, program instructions executed by SEP processor 1030 are signed by a trusted authority (e.g., system 120's manufacturer) in order to ensure their integrity. These program instructions may include those stored in secure ROM 1040 and program instructions stored externally such as in memory 220; however, these externally stored program instructions may have their signatures verified by program instructions in ROM 1040 prior to being permitted to be executed by processor 1030.

Cryptographic circuit 1050 is circuitry configured to perform cryptographic operations for SEP 230, including key generation, encryption and decryption using keys, signing using keys, which may be stored in secure memory 1060. Cryptographic circuit 1050 may implement any suitable encryption algorithm such as Data Encryption Standard (DES), Advanced Encryption Standard (AES), Rivest Shamir Adleman (RSA), etc. In some embodiments, circuit 1050 may further implement elliptic curve cryptography (ECC). In some embodiments, circuit 1050 may be responsible for generating keys 232 and 236 or using keys 232 and 236, which may be performed in response to a command from manager 1042 and using a random number generator (RNG) circuit, which may be included in circuit 1050 or accessible to circuit 1050 as a secure peripheral via interconnect 1070.

Secure memory 1060 may include a local memory (i.e., internal memory) of SEP 230 configured to store key data, which may include keys 122A, 232A and 236A as well as verification log 720 in the illustrated embodiment. In some embodiments, this key data may include keys used to establish the secure channels between SEP 230 and other elements in system 120. In some embodiments, storage 1060 may be configured such that only cryptographic circuit 1050 is able to read and write data to storage 1060 including key data. For example, while key manager 1042 running on processor 1030 may be able to request generation of keys 122A, 232A, and 236A and performance of an action with respect to keys 122A, 232A and 236A, processor 1030 may not be able to read or write data to secure memory 1060. Thus, if processor 1030 were to execute compromised program instructions, processor 1030 would be unable to read and write keys 122A, 232A and 236A anyways as secure memory 1060 may, for example, lack the physical read and write interfaces to facilitate such actions for processor 1030. In some embodiments, cryptographic circuit 1050 may access other forms of storage, which may include other non-volatile storages such as listed below with respect to FIG. 14. In some embodiments, these other storages may also include a set of fuses that are burnt during a fabrication of SEP 230 (or more generally system 120) in order to record keys such as a unique identifier (UID), which may be used derive keys described herein such as private SIK 236A or private SIK 236A discussed above. In some embodiments, to expand its available storage, SEP 230 may store keys generated by cryptographic circuit 1050 externally to SEP 230, such as in memory 220, but encrypt those keys using one or more keys stored in secure memory 1060 or other internal storages.

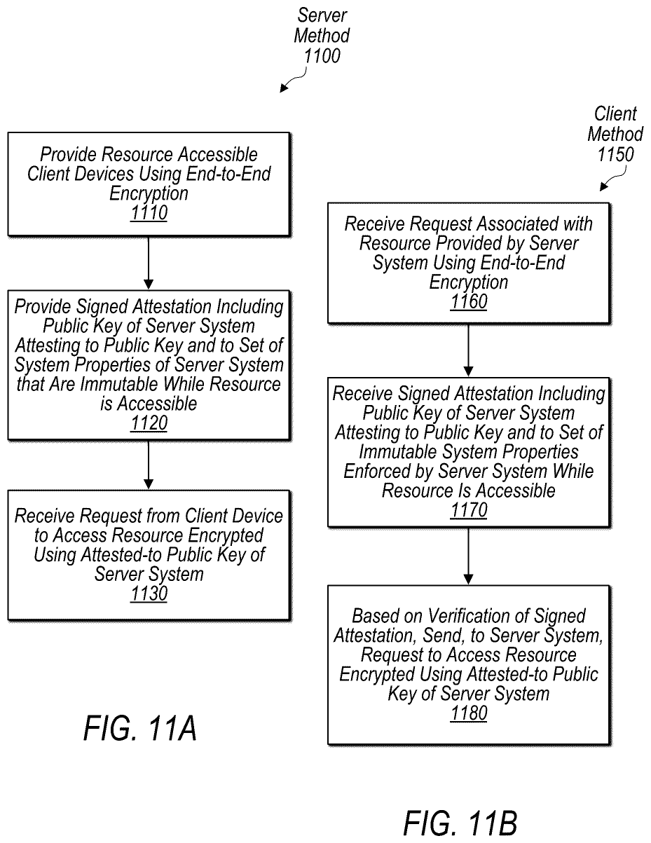

Turning now to FIG. 11A, a flow diagram of a method 1100 is depicted. Method 1100 is one embodiment of a method performed by a server system using an attestation attesting to immutable system properties such as server system 120.

Method 1100 begins in step 1110 with a server system providing a resource (e.g., LLM application 222) accessible to a plurality of client devices using end-to-end encryption. In step 1120, the server system provides a signed attestation (e.g., key attestation 124) that includes a public key (e.g., public REK 122B) of the server system, the attestation attesting to the public key and to a set of system properties (e.g., immutable system properties 532) of the server system that are immutable while the resource is accessible. In step 1130, the server system receives a request (e.g., request 132) from one of the client devices to access the resource, the request being encrypted using the attested-to public key of the server system.

Turning now to FIG. 11B, a flow diagram of a method 1150 is depicted. Method 1150 is one embodiment of a method performed by a client device using an attestation attesting to immutable system properties such as device 110.

Method 1150 begins in step 1160 with a device receiving a request associated with a resource (e.g., LLM application 222) provided by a server system (e.g., server system 120) using end-to-end encryption. In step 1170, the device receives a signed attestation (e.g., attestation 124) that includes a public key (e.g., public REK 122B) of the server system, the attestation attesting to the public key and to a set of immutable system properties (e.g., immutable system properties 532) enforced by the server system while the resource is accessible. In step 1180, based on a verification of the signed attestation, the device sends, to the server system, a request (e.g., request 132) to access the resource, the access request being encrypted using the attested-to public key of the server system.

### Load Balancing Across Server Systems

Machine learning (ML) work (or other compute tasks) can be notoriously resource and time-intensive, making it challenging to scale efficiently. To alleviate this issue, load balancing across multiple servers can help distribute the workload more effectively. Increasing the number of server systems to hundreds (or even thousands) can also provide greater capacity to distribute work for processing. As the number of servers grows, however, so too does the attack surface, as each additional server represents a new potential entry point for an attacker. Moreover, requiring client devices to encrypt requests to each server system's attested-to public key can become a significant burden, adding complexity and overhead.

The present disclosure describes embodiments in which an improved system of load balancing is employed when the number of available server systems is sufficiently scaled. As will be discussed below in various embodiments, a load balancer responsible for distributing requests to server systems can receive a request from a client device to access one of the server systems providing a resource and communicating using end-to-end encryption. The load balancer can then select a subset of the public-key attestations from the total pool of available system servers and provides merely the subset to the client device. The load balancer can receive a second encrypted request to use the resource, the request being encrypted using the attested-to public keys of the first subset of server systems. The load balancer can then distribute the second request to, at least, one of the first subset of server systems. If, however, the load balancer receives an indication that the first subset of server systems is unable to process the second request, the load balancer can provide a second set of public-key attestations for a second subset of the system servers to the client device. By providing only a subset of public-key attestations at a given time, the load balancer reduces the number of potential server systems with the ability to decrypt the encrypted request. Thus, if a server system in a larger cluster with, for example, thousands of server systems is ever compromised, the likelihood that a client device encrypts to that server system is reduced.

In some embodiments, the server systems may also participate in load balancing. As will be discussed, a first server system may provide, to a client device, a first public-key attestation attesting to a first public key of the first server system and a first set of system properties of the first server system. The first server system may then receive, from the client device, a request to access a resource provided by the first server system, the request including data encrypted using the first public key of the first server system. In response to determining that the first server system is unable to service the request, the first server system can send the request to a second server system providing the resource as long as the second server system has a second set of attested-to system properties that are the same (or, at least, include) the first set of system properties, which, in some embodiments, may include the immutable system properties discussed above. In doing so, the first server system can ensure continuity of these properties, so that the request is processed using the same standard that would be afforded if the first server system was able to service the request itself.

Turning now to FIG. 12A, a block diagram of a load balancing 1200 is depicted. In the illustrated embodiment, load balancing 1200 begins with a client device 110 sending a prefetch request 1202 for an initial set of key attestations 124. In some embodiments, this request 1202 is sent prior to device 110 receiving a query 112, such as when a user initially opens LLM client 130, in order to reduce the time needed to service any subsequently received queries 112. In response to receiving request 1202, load balancer 330 selects an initial set of key attestations 124A corresponding to server systems 120A and sends the selected set to client device 110. If load balance 330 later receives a request 132 encrypted using the public REK s 122B of server systems 120A but determines that none is able to service the request 132, load balancer 330 may select another set of key attestations 124B corresponding server systems 120B and provide them to device 110. Client device 110 may provide another request 132B encrypted using the public REK s 122B of server systems 120B. If a server system 120B is available, load balancer 330 may distribute the request 132B to server system 120B for servicing. If not, this exchange may continue until there is an available server system 120 to service a received request 132.

Load balancer 330 may use any suitable selection algorithm for selecting key attestations 124. Load balancer 330 may, for example, using a random selection algorithm using a random number genitor to select a subset of attestations 124/server systems 120. As another example, load balancer 330 may use a round robin distribution scheme. In some embodiments, load balancer 330 selects a subset of attestations 124 based on the requested resource (or desired system properties included in attestations 124) specified in prefetch request 1202. In particular, server systems 120 may provide multiple different resources such as different ML models, different accelerator hardware, etc. Load balancer 330 may limit its selection to only those server systems 120 offering the requested resource. In some embodiments, load balancer 330 receives workload information from server systems 120 (or some other indication of an ability to service requests) and distributes requests 132 based on current workloads. In some embodiments, load balancer 330 can alternatively determining that none of the first subset of server systems is currently available to service a request 132 and, based on the determining, temporarily buffer the request 132 until one of the subset of server systems 120 becomes available. In some embodiments, load balancer 330 validates key attestations 124 prior to providing them to a client device 110 in order to not deliver any invalid attestations 124.

As noted above, server systems 120 may also participate in load balancing in order to reduce the latency incurred when a sever system 120 receives a request 132 that it is unable to currently service.

Turning now to FIG. 12B, a block diagram of server-based loading balancing 1250 is depicted. In the illustrated embodiment, balancing 1250 again includes load balancer 330 providing one or more key attestations 124 and receiving a corresponding request 132, which load balancer 330 distributes to server system 120A. Server system 120A may determine that it is unable to currently service the request 132. Rather than notify load balancer 330 to cause it to send out another set of attestations 124, however, server system 120A instead forwards the request 132 to another server system 120B with availability to service the request 132.

In various embodiments, server system 120A re-encrypts the request 132 before forwarding the request 132 onwards to server system 120B. This may include server system 120A decrypting the encrypted request 132 using its private REK 122A and encrypting the decrypted request 132 using server systems 120B's public REK 122B attested to by its attestation 124. In some embodiments, this re-encryption may further include server system 120A using its private REK 122A to decrypt an encrypted symmetric key 224 that encrypts the encrypted data in request 132 and encrypting the decrypted symmetric key 224 using system server 120B's public REK 122B.

As discussed in the section above, server system 120A's attestation 124 may identify various system properties about server system 120 that can cause a client 110 to select the server system 120A such as immutable system properties 532 indicating that server system 120A can securely handle the contents of request 132. If server system 120A were to forward the request 132 to another server system 120B that lacked ones of these properties, server system 120A's attestation 124 would not be accurately conveying how the request 132 is being handled. For this reason, server system 120A may be configured to confirm that server system 120B's attestation 124 attests to at least the same properties attested to by server system 120A's attestation 124 before sending the request 132 onward. In doing so, server system 120A can still remain compliant with the system properties attested to in its attestation 124. In some embodiments, server system 120A's attestation 124 provides an indication of server system 120A's ability to forward a request 132. In the illustrated embodiment, server system 120A's attestation 124 includes addition information 1252 about server system 120B such as a release hash 762 associated with server system 120B, a unique identifier of system 120B, a hash of system 120B's attestation 124, etc. in order to attest to server system 120B.

Turning now to FIG. 13A, a flow diagram of a method 1300 is depicted. Method 1300 is one embodiment of a method performed by a load balancer such as load balancer 330.

Method 1300 begins in step 1310 with a load balancer receiving a first request (e.g., prefetch request 1202) from a client device (e.g., client device 110) to access one of a plurality of server systems (e.g., server systems 120) providing a resource and communicating using end-to-end encryption. In step 1320, the load balancer provides, to the client device, a first set of public-key attestations (e.g., key attestations 124A in FIG. 12A) for a first subset of the plurality of server systems. In such an embodiment, a given one of the public-key attestations includes a public key (e.g., public REK 122B) of one of the first subset of server systems. In step 1330, the load balancer receives, from the client device, a second request (e.g., encrypted request 132A) to use the resource, the second request being encrypted using the attested-to public keys of the first subset of server systems. In step 1340, the load balancer distributes the second request to, at least, one of the first subset of server systems. In some embodiments, method 1300 further includes the load balancer receiving an indication that the first subset of server systems is unable to process the second request and, based on the indication, the load balancer providing a second set of public-key attestations (e.g., key attestations 124B in FIG. 12A) for a second subset of the system servers to the client device.

Turning now to FIG. 13B, a flow diagram of a method 1350 is depicted. Method 1350 is one embodiment of a method performed by a server system, such as server system 120, that assists in load balancing.

Method 1350 begins in step 1360 with a first server system (e.g., server system 120A in FIG. 12B) providing, to a client device (e.g., client device 110), a first public-key attestation (e.g., key attestation 124) attesting to a first public key of the first server system and a first set of system properties of the first server system. In step 1370, the first server system receives, from the client device, a request (e.g., request 132) to access a resource provided by the first server system, the requesting includes data encrypted using the first public key of the first server system. In step 1380, in response to determining that the first server system is unable to service the request, the first server system sends the request to a second server system (e.g., server system 120B in FIG. 12B) providing the resource and having a second set of attested-to system properties that includes the first set of system properties.

### Exemplary Computing System

Turning now to FIG. 14, a block diagram illustrating an example embodiment of a computing system 1400 is shown. In some embodiments, client device 110, server system 120, or other elements discussed above include components of computing system 1400 or may implement functionality of described with respect to computing system 1400. In some embodiments, elements of computing system 1400 may be included within a system on a chip (SoC). In some embodiments, computing system 1400 may be included in a mobile computing device, which may be battery-powered. Therefore, power consumption by computing system 1400 may be an important design consideration. In the illustrated embodiment, computing system 1400 includes fabric 1410, compute complex 1420 (corresponding to processors 210 in some embodiments), input/output (I/O) bridge 1460, cache/memory controller 1430, graphics unit 1440, and display unit 1450. In some embodiments, device 1400 may include other components (not shown) in addition to or in place of the illustrated components, such as video processor encoders and decoders, image processing or recognition elements, computer vision elements, etc.

Fabric 1410 may include various interconnects, buses, MUX's, controllers, etc., and may be configured to facilitate communication between various elements of computing system 1400. In some embodiments, portions of fabric 1410 may be configured to implement various different communication protocols. In other embodiments, fabric 1410 may implement a single communication protocol and elements coupled to fabric 1410 may convert from the single communication protocol to other communication protocols internally.

In the illustrated embodiment, compute complex 1420 includes bus interface unit (BIU) 1422, cache 1424, and cores 1426A-B. In various embodiments, compute complex 1420 may include various numbers of processors, processor cores and caches. For example, compute complex 1420 may include 1, 2, or 4 processor cores, or any other suitable number. In one embodiment, cache 1424 is a set associative L2 cache. In some embodiments, cores 1426A-B may include internal instruction and data caches. In some embodiments, a coherency unit (not shown) in fabric 1410, cache 1424, or elsewhere in device 1400 may be configured to maintain coherency between various caches of computing system 1400. BIU 1422 may be configured to manage communication between compute complex 1420 and other elements of computing system 1400. Processor cores such as cores 1426A-B may be configured to execute instructions of a particular instruction set architecture (ISA) which may include operating system instructions and user application instructions. These instructions may be stored in computer readable medium such as a memory coupled to memory controller 1430 discussed below.

As used herein, the term “coupled to” may indicate one or more connections between elements, and a coupling may include intervening elements. For example, in FIG. 14, graphics unit 1440 may be described as “coupled to” a memory through fabric 1410 and cache/memory controller 1430. In contrast, in the illustrated embodiment of FIG. 14, graphics unit 1440 is “directly coupled” to fabric 1410 because there are no intervening elements.

Cache/memory controller 1430 may be configured to manage transfer of data between fabric 1410 and one or more caches and memories such as memory 220. For example, cache/memory controller 1430 may be coupled to an L3 cache, which may in turn be coupled to a system memory. In other embodiments, cache/memory controller 1430 may be directly coupled to a memory. In some embodiments, cache/memory controller 1430 may include one or more internal caches. Memory coupled to controller 1430 may be any type of volatile memory, such as dynamic random access memory (DRAM), synchronous DRAM (SDRAM), double data rate (DDR, DDR2, DDR3, etc.) SDRAM (including mobile versions of the SDRAM s such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1430 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as those to implement LLM 130, LLM Application 222, applications 510, enforcement agents 520, etc., executable by compute complex 1420 to cause computing system 1400 to perform functionality described herein.

Graphics unit 1440 may include one or more processors, e.g., one or more graphics processing units (GPUs). Graphics unit 1440 may receive graphics-oriented instructions, such as OPENGL®, Metal®, or DIRECT 3D® instructions, for example. Graphics unit 1440 may execute specialized GPU instructions or perform other operations based on the received graphics-oriented instructions. Graphics unit 1440 may generally be configured to process large blocks of data in parallel and may build images in a frame buffer for output to a display, which may be included in the device or may be a separate device. Graphics unit 1440 may include transform, lighting, triangle, and rendering engines in one or more graphics processing pipelines. Graphics unit 1440 may output pixel information for display images. Graphics unit 1440, in various embodiments, may include programmable shader circuitry which may include highly parallel execution cores configured to execute graphics programs, which may include pixel tasks, vertex tasks, and compute tasks (which may or may not be graphics-related).

Display unit 1450 may be configured to read data from a frame buffer and provide a stream of pixel values for display. Display unit 1450 may be configured as a display pipeline in some embodiments. Additionally, display unit 1450 may be configured to blend multiple frames to produce an output frame. Further, display unit 1450 may include one or more interfaces (e.g., MIPI® or embedded display port (eDP)) for coupling to a user display (e.g., a touchscreen or an external display).

I/O bridge 1460 may include various elements configured to implement: universal serial bus (USB) communications, security, audio, and low-power always-on functionality, for example. I/O bridge 1460 may also include interfaces such as pulse-width modulation (PWM), general-purpose input/output (GPIO), serial peripheral interface (SPI), and inter-integrated circuit (I2C), for example. Various types of peripherals and devices may be coupled to device 1400 via I/O bridge 1460.

In some embodiments, computing system 1400 includes network interface circuitry (not explicitly shown), which may be connected to fabric 1410 or I/O bridge 1460. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide computing system 1400 with connectivity to various types of other devices and networks.

### Example Applications

Turning now to FIG. 15, various types of systems that may implement or include any of the circuits, devices, or system discussed above. System or device 1500, which may incorporate or otherwise utilize one or more of the techniques described herein, may be utilized in a wide range of areas. For example, system or device 1500 may be utilized as part of the hardware of systems such as a desktop computer 1510, laptop computer 1520, tablet computer 1530, cellular or mobile phone 1540, or television 1550 (or set-top box coupled to a television).

Similarly, disclosed elements may be utilized in a wearable device 1560, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1500 may also be used in various other contexts. For example, system or device 1500 may be utilized in the context of a server computer system, such as a dedicated server or on shared hardware that implements a cloud-based service 1570. Still further, system or device 1500 may be implemented in a wide range of specialized everyday devices, including devices 1580 commonly found in the home such as refrigerators, thermostats, security cameras, etc. The interconnection of such devices is often referred to as the “Internet of Things” (IT). Elements may also be implemented in various modes of transportation. For example, system or device 1500 could be employed in the control systems, guidance systems, entertainment systems, etc. of various types of vehicles 1590.

The applications illustrated in FIG. 15 are merely exemplary and are not intended to limit the potential future applications of disclosed systems or devices. Other example applications include, without limitation: portable gaming devices, music players, data storage devices, unmanned aerial vehicles, etc.

### Example Application Programing Interfaces (APIs)

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

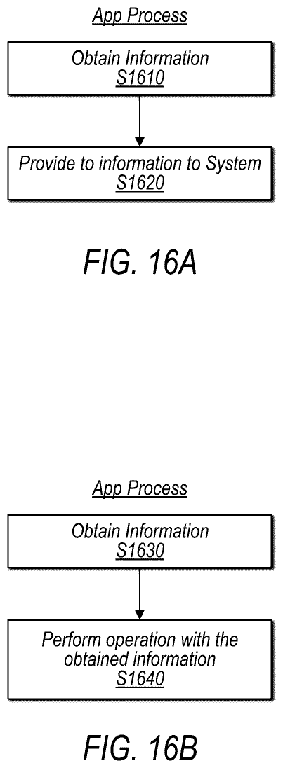

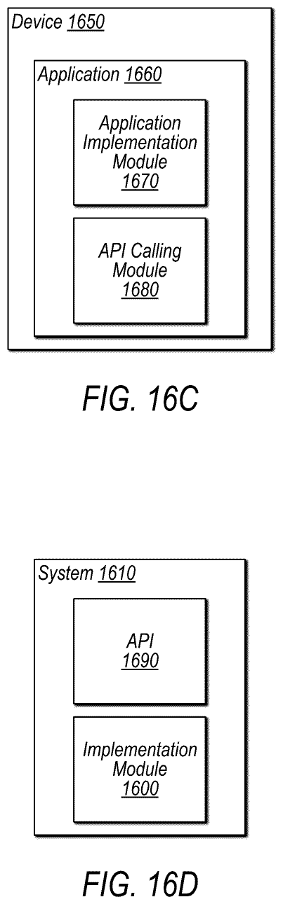

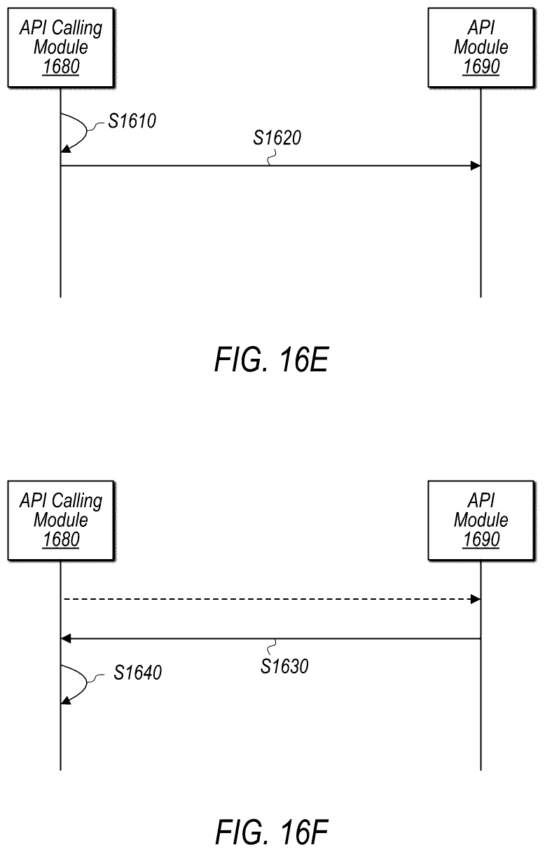

Implementations within the scope of the present disclosure include a computer-readable storage medium that encodes instructions organized as an application (e.g., application 1660) that, when executed by one or more processing units, control an electronic device (e.g., device 110) to perform the method of FIG. 16A, the method of FIG. 16B, and/or one or more other processes and/or methods described herein.

It should be recognized that application 1660 (shown in FIG. 16C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1660 is an application that is pre-installed on device 1650 at purchase (e.g., a first party application). In other embodiments, application 1660 is an application that is provided to device 1650 via an operating system update file (e.g., a first party application or a second party application). In other embodiments, application 1660 is an application that is provided via an application store. In some embodiments, the application store can be an application store that is pre-installed on device 1650 at purchase (e.g., a first party application store). In other embodiments, the application store is a third-party application store (e.g., an application store that is provided by another application store, downloaded via a network, and/or read from a storage device).

Referring to FIG. 16A and FIG. 16E, application 1660 obtains information (e.g., S1610). In some embodiments, at S1610, information is obtained from at least one hardware component of the device 1650. In some embodiments, at S1610, information is obtained from at least one software module of the device 1650. In some embodiments, at S1610, information is obtained from at least one hardware component external to the device 1650 (e.g., a peripheral device, an accessory device, a server, etc.). In some embodiments, the information obtained at S1610 includes positional information, time information, notification information, user information, environment information, electronic device state information, weather information, media information, historical information, event information, hardware information, and/or motion information. In some embodiments, in response to and/or after obtaining the information at S1610, application 1660 provides the information to a system (e.g., S1620).

In some embodiments, the system (e.g., 1610 shown in FIG. 16E) is an operating system hosted on the device 1650. In some embodiments, the system (e.g., 1610 shown in FIG. 16E) is an external device (e.g., a server, a peripheral device, an accessory, a personal computing device, etc.) that includes an operating system.

Referring to FIG. 16B and FIG. 16F, application 1660 obtains information (e.g., S1630). In some embodiments, the information obtained at S1630 includes positional information, time information, notification information, user information, environment information electronic device state information, weather information, media information, historical information, event information, hardware information and/or motion information. In response to and/or after obtaining the information at S1630, application 1660 performs an operation with the information (e.g., S1640). In some embodiments, the operation performed at S1640 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1610 based on the information.

In some embodiments, one or more steps of the method of FIG. 16A and/or the method of FIG. 16B is performed in response to a trigger. In some embodiments, the trigger includes detection of an event, a notification received from system 1610, a user input, and/or a response to a call to an API provided by system 1610.

In some embodiments, the instructions of application 1660, when executed, control device 1650 to perform the method of FIG. 16A and/or the method of FIG. 16B by calling an application programming interface (API) (e.g., API 1690) provided by system 1610. In some embodiments, application 1660 performs at least a portion of the method of FIG. 16A and/or the method of FIG. 16B without calling API 1690.

In some embodiments, one or more steps of the method of FIG. 16A and/or the method of FIG. 16B includes calling an API (e.g., API 1690) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 16C, device 1650 is illustrated. In some embodiments, device 1650 is a personal computing device, a smart phone, a smart watch, a fitness tracker, a head mounted display (HMD) device, a media device, a communal device, a speaker, a television, and/or a tablet. As illustrated in FIG. 16C, device 1650 includes application 1660 and operating system (e.g., system 1610 shown in FIG. 16D). Application 1660 includes application implementation module 1670 and API calling module 1680. System 1610 includes API 1690 and implementation module 1600. It should be recognized that device 1650, application 1660, and/or system 1610 can include more, fewer, and/or different components than illustrated in FIGS. 16C and 16D.

In some embodiments, application implementation module 1670 includes a set of one or more instructions corresponding to one or more operations performed by application 1660. For example, when application 1660 is a messaging application, application implementation module 1670 can include operations to receive and send messages. In some embodiments, application implementation module 1670 communicates with API calling module to communicate with system 1610 via API 1690 (shown in FIG. 16D).

In some embodiments, API 1690 is a software module (e.g., a collection of computer-readable instructions) that provides an interface that allows a different module (e.g., API calling module 1680) to access and/or use one or more functions, methods, procedures, data structures, classes, and/or other services provided by implementation module 1600 of system 1610. For example, API-calling module 1680 can access a feature of implementation module 1600 through one or more API calls or invocations (e.g., embodied by a function or a method call) exposed by API 1690 and can pass data and/or control information using one or more parameters via the API calls or invocations. In some embodiments, API 1690 allows application 1660 to use a service provided by a Software Development Kit (SDK) library. In other embodiments, application 1660 incorporates a call to a function or method provided by the SDK library and provided by API 1690 or uses data types or objects defined in the SDK library and provided by API 1690. In some embodiments, API-calling module 1680 makes an API call via API 1690 to access and use a feature of implementation module 1600 that is specified by API 1690. In such embodiments, implementation module 1600 can return a value via API 1690 to API-calling module 1680 in response to the API call. The value can report to application 1660 the capabilities or state of a hardware component of device 1650, including those related to aspects such as input capabilities and state, output capabilities and state, processing capability, power state, storage capacity and state, and/or communications capability. In some embodiments, API 1690 is implemented in part by firmware, microcode, or other low level logic that executes in part on the hardware component.

In some embodiments, API 1690 allows a developer of API-calling module 1680 (which can be a third-party developer) to leverage a feature provided by implementation module 1600. In such embodiments, there can be one or more API-calling modules (e.g., including API-calling module 1680) that communicate with implementation module 1600. In some embodiments, API 1690 allows multiple API-calling modules written in different programming languages to communicate with implementation module 1600 (e.g., API 1690 can include features for translating calls and returns between implementation module 1600 and API-calling module 1680) while API 1690 is implemented in terms of a specific programming language. In some embodiments, API-calling module 1680 calls APIs from different providers such as a set of A Pls from an OS provider, another set of A Pls from a plug-in provider, and/or another set of APIs from another provider (e.g., the provider of a software library) or creator of the another set of APIs.

Examples of API 1690 can include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1650. For example, the sensor API can provide access to raw sensor data. For another example, the sensor API can provide data derived (and/or generated) from the raw sensor data. In some embodiments, the sensor data includes temperature data, image data, video data, audio data, heart rate data, IM U (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1600 is a system (e.g., operating system, server system) software module (e.g., a collection of computer-readable instructions) that is constructed to perform an operation in response to receiving an API call via API 1690. In some embodiments, implementation module 1600 is constructed to provide an API response (via API 1690) as a result of processing an API call. By way of example, implementation module 1600 and API-calling module 180 can each be any one of an operating system, a library, a device driver, an API, an application program, or other module. It should be understood that implementation module 1600 and API-calling module 1680 can be the same or different type of module from each other. In some embodiments, implementation module 1600 is embodied at least in part in firmware, microcode, or other hardware logic.

In some embodiments, implementation module 1600 returns a value through API 1690 in response to an API call from API-calling module 1680. While API 1690 defines the syntax and result of an API call (e.g., how to invoke the API call and what the API call does), API 1690 might not reveal how implementation module 1600 accomplishes the function specified by the API call. Various API calls are transferred via the one or more application programming interfaces between API-calling module 1680 and implementation module 1600. Transferring the API calls can include issuing, initiating, invoking, calling, receiving, returning, and/or responding to the function calls or messages. In other words, transferring can describe actions by either of API-calling module 1680 or implementation module 1600. In some embodiments, a function call or other invocation of API 1690 sends and/or receives one or more parameters through a parameter list or other structure.

In some embodiments, implementation module 1600 provides more than one API, each providing a different view of or with different aspects of functionality implemented by implementation module 1600. For example, one API of implementation module 1600 can provide a first set of functions and can be exposed to third party developers, and another API of implementation module 1600 can be hidden (e.g., not exposed) and provide a subset of the first set of functions and also provide another set of functions, such as testing or debugging functions which are not in the first set of functions. In some embodiments, implementation module 1600 calls one or more other components via an underlying API and thus be both an API calling module and an implementation module. It should be recognized that implementation module 1600 can include additional functions, methods, classes, data structures, and/or other features that are not specified through API 1690 and are not available to API calling module 1680. It should also be recognized that API calling module 1680 can be on the same system as implementation module 1600 or can be located remotely and access implementation module 1600 using API 1690 over a network. In some embodiments, implementation module 1600, API 1690, and/or API-calling module 1680 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, LLM client 130 is an application (e.g., 1660). In some embodiments, LLM client 130 is an application implementation module (e.g., 1670) included in an application (e.g., 1660). In some embodiments, LLM client 130 is an API calling module (e.g., 1680) included in an application (e.g., 60). In some embodiments, LLM client 130 functions to allow application 1660 to uses a service provided by the server systems 120. In some embodiments, LLM client 130 functions to allow application 1660 to uses a service provided by the server systems 120 by using a service provided by a Software Development Kit (SDK) library. In other embodiments, application 1660 incorporates a call to a function or method provided by the SDK library and provided by API 1690 or uses data types or objects defined in the SDK library and provided by API 1690.

In some embodiments, method 400 (FIG. 4A) is performed at a first computer system (e.g., 110 as described herein) via a system process (e.g., an operating system process, a server system process) that is different from one or more applications executing and/or installed on the first computer system.

In some embodiments, method 400 (FIG. 4A) is performed at a first computer system (e.g., 110 as described herein) by an application that is different from a system process. In some embodiments, the instructions of the application, when executed, control the first computer system to perform method 400 (FIG. 4A) by calling an application programming interface (API) provided by the system process. In some embodiments, the application performs at least a portion of method 400 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 400 (FIG. 4A) by calling an application programming interface (API) provided by the system process using one or more parameters.

In some embodiments, exemplary APIs provided by the system process include one or more of: an LLM processing API, a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1690 defines an LLM processing API call that can be provided by API calling module 1690, wherein the definition for the API call specifies the following call parameters: encrypted request data 132. In some embodiments, the API 1690 defines an LLM processing API call that can be provided by API calling module 1690, wherein the definition for the API call specifies the following call parameters: encrypted request data 132 and encrypted message key 224. In some embodiments, the API 1690 defines an LLM processing API call that can be provided by API calling module 1690, wherein the definition for the API call specifies the following call parameters: encrypted message key 224. In some embodiments, the API 1690 defines an LLM processing API call that can be provided by API calling module 1690, wherein the definition for the API call specifies the following call parameters: encrypted request data 132, encrypted TGT 314, and signed OTT 322. In some embodiments, the API 1690 defines an LLM processing API call that can be provided by API calling module 1690, wherein the definition for the API call specifies the following call parameters: encrypted TGT 314. In some embodiments, the API 1690 defines an LLM processing API call that can be provided by API calling module 1690, wherein the definition for the API call specifies the following call parameters: signed OTT 322. In some embodiments, the API 1690 defines an LLM processing API call that can be provided by API calling module 1690, wherein the definition for the API call specifies the following call parameters: encrypted TGT 314 and signed OTT 322. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1650) that runs the application. In some embodiments, the implementation module is included in an electronic device that is separate from the device that runs the application.

In some embodiments, method 1150 (FIG. 11B) is performed at a first computer system (e.g., 110 as described herein) via a system process (e.g., an operating system process, a server system process) that is different from one or more applications executing and/or installed on the first computer system.

In some embodiments, method 1150 (FIG. 11B) is performed at a first computer system (e.g., 110 as described herein) by an application that is different from a system process. In some embodiments, the instructions of the application, when executed, control the first computer system to perform method 1150 (FIG. 11B) by calling an application programming interface (API) provided by the system process. In some embodiments, the application performs at least a portion of method 1150 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 1150 (FIG. 11A) by calling an application programming interface (API) provided by the system process using one or more parameters.

In some embodiments, exemplary APIs provided by the system process include one or more of: an LLM processing API, a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1690 defines an LLM processing API call that can be provided by API calling module 1690, wherein the definition for the API call specifies the following call parameters: encrypted request data 132. In some embodiments, the API 1690 defines an LLM processing API call that can be provided by API calling module 1690, wherein the definition for the API call specifies the following call parameters: encrypted request data 132 and encrypted message key 224. In some embodiments, the API 1690 defines an LLM processing API call that can be provided by API calling module 1690, wherein the definition for the API call specifies the following call parameters: encrypted message key 224. In some embodiments, the API 1690 defines an LLM processing API call that can be provided by API calling module 1690, wherein the definition for the API call specifies the following call parameters: encrypted request data 132, encrypted TGT 314, and signed OTT 322. In some embodiments, the API 1690 defines an LLM processing API call that can be provided by API calling module 1690, wherein the definition for the API call specifies the following call parameters: encrypted TGT 314. In some embodiments, the API 1690 defines an LLM processing API call that can be provided by API calling module 1690, wherein the definition for the API call specifies the following call parameters: signed OTT 322. In some embodiments, the API 1690 defines an LLM processing API call that can be provided by API calling module 1690, wherein the definition for the API call specifies the following call parameters: encrypted TGT 314 and signed OTT 322. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1650) that runs the application. In some embodiments, the implementation module is included in an electronic device that is separate from the device that runs the application.

In some embodiments, method 1350 (FIG. 13B) is performed at a first computer system (e.g., 110 as described herein) via a system process (e.g., an operating system process, a server system process) that is different from one or more applications executing and/or installed on the first computer system.

In some embodiments, method 1350 (FIG. 13B) is performed at a first computer system (e.g., 110 as described herein) by an application that is different from a system process. In some embodiments, the instructions of the application, when executed, control the first computer system to perform method 1350 (FIG. 13B) by calling an application programming interface (API) provided by the system process. In some embodiments, the application performs at least a portion of method 1350 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 1350 (FIG. 13B) by calling an application programming interface (API) provided by the system process using one or more parameters.

In some embodiments, exemplary APIs provided by the system process include one or more of: an LLM processing API, a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a Wi-Fi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1690 defines an LLM processing API call that can be provided by API calling module 1690, wherein the definition for the API call specifies the following call parameters: encrypted request data 132. In some embodiments, the API 1690 defines an LLM processing API call that can be provided by API calling module 1690, wherein the definition for the API call specifies the following call parameters: encrypted request data 132 and encrypted message key 224. In some embodiments, the API 1690 defines an LLM processing API call that can be provided by API calling module 1690, wherein the definition for the API call specifies the following call parameters: encrypted message key 224. In some embodiments, the API 1690 defines an LLM processing API call that can be provided by API calling module 1690, wherein the definition for the API call specifies the following call parameters: encrypted request data 132, encrypted TGT 314, and signed OTT 322. In some embodiments, the API 1690 defines an LLM processing API call that can be provided by API calling module 1690, wherein the definition for the API call specifies the following call parameters: encrypted TGT 314. In some embodiments, the API 1690 defines an LLM processing API call that can be provided by API calling module 1690, wherein the definition for the API call specifies the following call parameters: signed OTT 322. In some embodiments, the API 1690 defines an LLM processing API call that can be provided by API calling module 1690, wherein the definition for the API call specifies the following call parameters: encrypted TGT 314 and signed OTT 322. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1650) that runs the application. In some embodiments, the implementation module is included in an electronic device that is separate from the device that runs the application.

As described herein, content can be automatically generated by one or more computers in response to a request to generate the content (e.g., a request to an LLM client, a request to a server that provides LLM services via an LLM Application, etc.). The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LL M s). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/M L systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. A ny temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the A l/M L systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the A l/M L systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the A l/M L systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages.

Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A method, comprising:
providing, by a server system, a resource accessible to a plurality of client devices using end-to-end encryption;
providing, by the server system, a signed attestation that includes a public key of the server system, wherein the attestation attests to the public key and to a set of system properties of the server system that are immutable while the resource is accessible; and
receiving, by the server system, a request from one of the client devices to access the resource, wherein the request is encrypted using the attested-to public key of the server system.

2. The method of claim 1, further comprising:
publishing, by the server system, information about the immutable system properties to a transparency log stored in a transparency server accessible to the client device when verifying the signed attestation.

3. The method of claim 2, wherein the publish information includes information that uniquely identifies one or more components within the server system and information about an operating system executing on the server system.

4. The method of claim 1, wherein the set of immutable system properties identify an enforced set of applications authorized to execute while the resource is accessible.

5. The method of claim 4, wherein the set of immutable system properties include signed digests generated from hashing program instructions of the authorized applications.

6. The method of claim 1, wherein the set of immutable system properties includes an indication of particular hardware included in the server system and used to provide the resource.

7. The method of claim 1, further comprising:
enforcing, by the server system, the set of immutable system properties by entering a restricted execution mode (REM) in which the server system executes only a set of authorized applications while the resource is accessible.

8. The method of claim 7, wherein entering the REM includes:
deallocating, by the server system, portions of memory assigned to user space to clear user space of application data associated with applications executing prior to entering the REM; and
after the deallocating, initiating execution of only ones of the set of applications authorized to execute during the REM, wherein the applications authorized to execute during the REM store data in the cleared user space.

9. The method of claim 1, further comprising:
enforcing, by an enforcement agent of the server system, the set of immutable system properties by:
accessing one or more manifests identifying a set of signatures generated from signing applications and a set of criteria in which the applications are authorized to execute;
confirming verification of the signatures; and
enforcing the criteria for the applications.

10. The method of claim 1, further comprising:
receiving, by a secure circuit of the server system, information from an enforcement agent enforcing the set of immutable system properties; and
signing, by the secure circuit, an attestation based on the information indicating that set of immutable system properties are being enforced by the enforcement agent.

11. The method of claim 10, wherein further comprising:
establish a secure communication channel between the secure circuit and the enforcement agent to exchange the information by allocating a portion of memory shared between the secure circuit and the enforcement agent such that the secure circuit and the enforcement agent are the only ones permitted to write to the allocated portion.

12. The method of claim 10, wherein the secure circuit is configured to sign the attestation using a private key stored in the secure circuit during fabrication of the server system.

13. The method of claim 1, wherein the resource includes a machine learning model hosted by the server system.

14. The method of claim 1, wherein the resource includes accelerator hardware configured to perform one or more tasks identified in the request.

15. The method of claim 1, wherein the resource includes an application hosted by the server system.

16. A non-transitory computer readable medium having program instructions stored therein that are executable by a server computing system to perform operations comprising:
providing a resource accessible to a plurality of client devices using end-to-end encryption;
providing a signed attestation that includes a public key of the server system, wherein the attestation attests to the public key and to a set of system properties of the server system that are immutable while the resource is accessible; and
receiving a request from one of the client devices to access the resource, wherein the request is encrypted using the attested-to public key of the server system.

17. The computer readable medium of claim 16, wherein the operations further comprise:
providing information about the immutable system properties to a transparency log in a transparency server accessible to the client device when verifying the signed attestation.

18. The computer readable medium of claim 16, wherein the set of immutable system properties include identifications of an enforced set of applications authorized to execute while the resource is accessible, signed digests generated from hashing program instructions of applications, or indications of particular hardware included in the server system and used to provide the resource.

19. The computer readable medium of claim 16, wherein the operations further comprise:
receiving, at a secure circuit of the server computer system, information from an enforcement agent enforcing the set of immutable system properties; and
signing, by the secure circuit, an attestation based on the information indicating that set of immutable system properties are being enforced by the enforcement agent.

20. A server computing system, comprising:
one or more processors; and
memory having program instructions stored therein that are executable by the one or more processors to cause the computing system to perform operations including:
providing a resource accessible to a plurality of client devices using end-to-end encryption;
providing a signed attestation that includes a public key of the server system, wherein the attestation attests to the public key and to a set of system properties of the server system that are immutable while the resource is accessible; and
receiving a request from one of the client devices to access the resource, wherein the request is encrypted using the attested-to public key of the server system.
